(19) United States
(12) Patent Application Publication
(10) Pub. No.: US 2023/0007455 A1
(43) Pub. Date: Jan. 5, 2023

(54) METHOD AND APPARATUS FOR RECEIVING PC5 SIGNALING (PC5-S) MESSAGES IN A WIRELESS COMMUNICATION SYSTEM

(71) Applicant: ASUSTek Computer Inc., Taipei City 112 (TW)

(72) Inventor: Richard Lee-Chee Kuo, Taipei City (TW)

(21) Appl. No.: 17/837,742

(22) Filed: Jun. 10, 2022

Related U.S. Application Data
(60) Provisional application No. 63/217,503, filed on Jul. 1, 2021.

(51) Int. Cl. H04W 4/40; H04W 40/22; H04W 76/10; H04W 12/106

(52) U.S. Cl. CPC H04W 4/40; H04W 40/22; H04W 76/10; H04W 12/106

(57) ABSTRACT

A method and device are disclosed for PC5 Signaling (PC5-S) message reception from the perspective of a UE-to-UE relay. The UE-to-UE relay receives a first PC5-S message on a first sidelink Signal Radio Bearer (SRB) from a first UE, wherein the first PC5-S message is used to establish a first sidelink security between the UE-to-UE relay and the first UE, to update link identifier(s) associated with a first link between the first UE and the UE-to-UE relay, or to modify the first link between the first UE and the UE-to-UE relay. The UE-to-UE relay also delivers the first PC5-S message to an upper layer of the UE-to-UE relay.

### CROSS-REFERENCE TO RELATED APPLICATIONS

The present Application claims the benefit of U.S. Provisional Patent Application Ser. No. 63/217,503 filed on Jul. 1, 2021, the entire disclosure of which is incorporated herein in its entirety by reference.

### FIELD

This disclosure generally relates to wireless communication networks, and more particularly, to a method and apparatus for receiving PC5-S messages in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device are disclosed for PC5 Signaling (PC5-S) message reception from the perspective of a UE-to-UE relay. In one embodiment, the UE-to-UE relay receives a first PC5-S message on a first sidelink Signal Radio Bearer (SRB) from a first UE, wherein the first PC5-S message is used to establish a first sidelink security between the UE-to-UE relay and the first UE, to update link identifier(s) associated with a first link between the first UE and the UE-to-UE relay, or to modify the first link between the first UE and the UE-to-UE relay. The UE-to-UE relay also delivers the first PC5-S message to an upper layer of the UE-to-UE relay. In addition, the UE-to-UE relay receives a second PC5-S message on a second sidelink SRB from the first UE, wherein the second PC5-S message is used to establish a second sidelink security between the first UE and a second UE, to update link identifier(s) associated with a second link between the first UE and the second UE, or to modify the second link between the first UE and the second UE. Furthermore, the UE-to-UE relay transmits or forwards the second PC5-S message to the second UE.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 5.2.1.4-1 of 3GPP TS 23.287 V16.2.0.

FIG. 6 is a reproduction of FIG. 6.1.1-1 of 3GPP TS 23.287 V16.2.0.

FIG. 7 is a reproduction of FIG. 6.1.2-1 of 3GPP TS 23.287 V16.2.0.

FIG. 8 is a reproduction of FIG. 6.3.3.1-1 of 3GPP TS 23.287 V16.2.0.

FIG. 9 is a reproduction of FIG. 6.3.3.2-1 of 3GPP TS 23.287 V16.2.0.

FIG. 10 is a reproduction of FIG. 6.3.3.4-1 of 3GPP TS 23.287 V16.2.0.

FIG. 11 is a reproduction of FIG. 6.2.2.1-1 of 3GPP TS 38.323 V16.0.0.

FIG. 12 is a reproduction of FIG. 6.9.1.2-1 of 3GPP TR 23.752 V0.4.0.

FIG. 13 is a reproduction of FIG. 6.9.1.2-2 of 3GPP TR 23.752 V0.4.0.

FIG. 14 is a reproduction of FIG. 6.9.2-1 of 3GPP TR 23.752 V0.4.0.

FIG. 15 is a reproduction of FIG. 6.9.2.2-1 of 3GPP TR 23.752 V0.4.0.

FIG. 16 is a reproduction of FIG. 6.31.2-1 of 3GPP TR 23.752 V0.4.0.

FIG. 17 is a reproduction of FIG. 6.31.3-1 of 3GPP TR 23.752 V0.4.0.

FIG. 18 is a reproduction of FIG. 5.5.1-1 of 3GPP TR 38.836 V1.0.0.

FIG. 19 is a reproduction of FIG. 5.5.1-2 of 3GPP TR 38.836 V1.0.0.

FIG. 20 is a diagram according to one exemplary embodiment.

FIG. 21 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 23.287 V16.2.0, “Architecture enhancements for 5G System (5GS) to support Vehicle-to-Everything (V2X) services (Release 16)”; TS 38.323 V16.0.0, “NR; Packet Data Convergence Protocol (PDCP) specification (Release 16)”; TS 38.331 V16.0.0, “NR; Radio Resource Control (RRC) protocol specification (Release 16)”; TR 23.752 V0.4.0, “Study on system enhancement for Proximity based services (ProSe) in the 5G System (5GS) (Release 17)”; and TR 38.836 V1.0.0, “Study on NR sidelink relay (Release 17)”. The standards and documents listed above are hereby expressly incorporated by reference in their entirety.

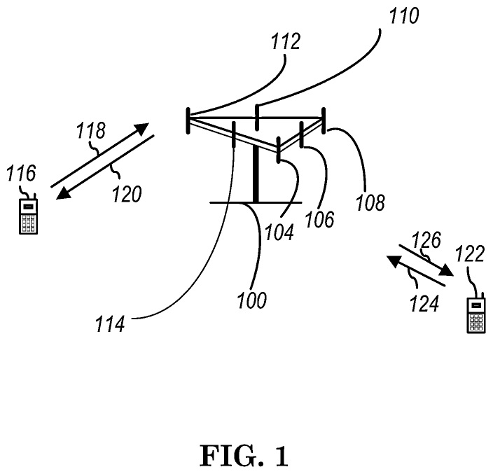

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

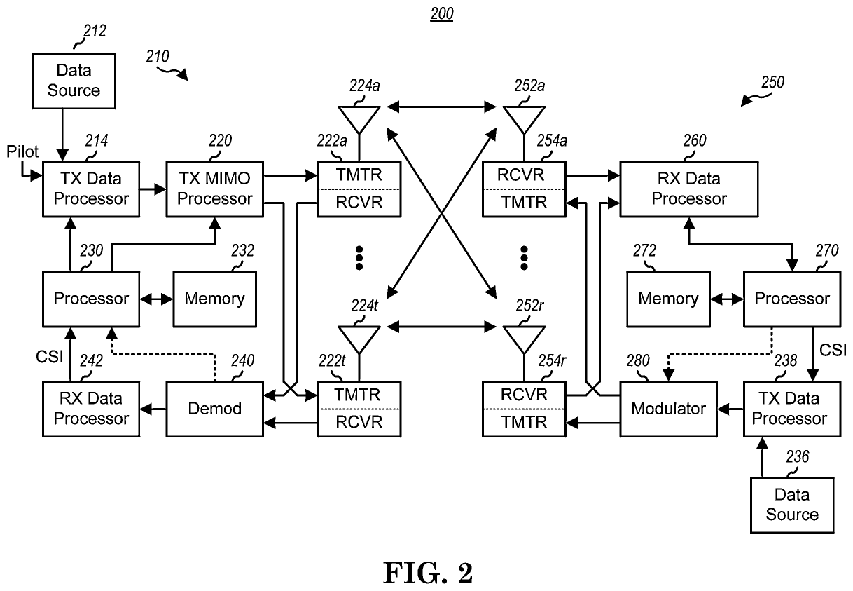

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

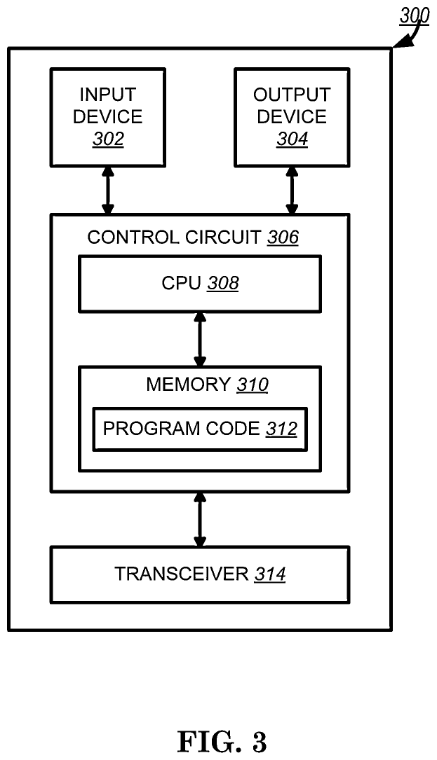

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

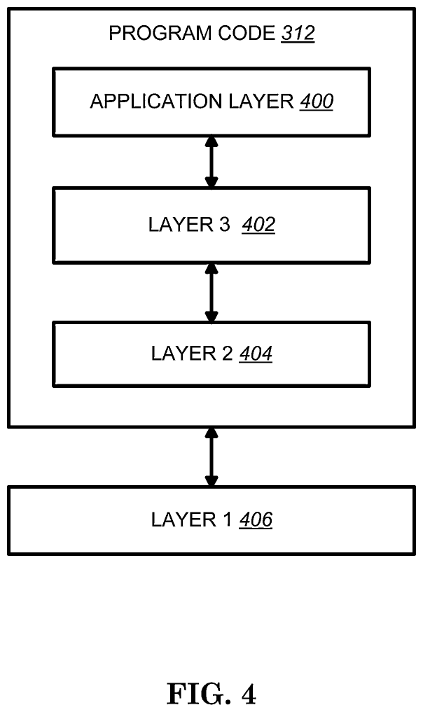

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 23.287 specifies procedures related to unicast mode Vehicle-to-Everything (V2X) communication over PC5 reference point as follows:

### 5.1.2 Authorization and Provisioning for V2X Communications Over PC5 Reference Point

### 5.1.2.1 Policy/Parameter Provisioning

The following sets of information for V2X communications over PC5 reference point is provisioned to the UE:
1) Authorization policy:
   When the UE is “served by E-UTRA” or “served by NR”:
      PLMNs in which the UE is authorized to perform V2X communications over PC5 reference point when “served by E-UTRA” or “served by NR”.
      For each above PLMN:
         RAT(s) over which the UE is authorized to perform V2X communications over PC5 reference point.
   When the UE is “not served by E-UTRA” and “not served by NR”:
      Indicates whether the UE is authorized to perform V2X communications over PC5 reference point when “not served by E-UTRA” and “not served by NR”.
      RAT(s) over which the UE is authorized to perform V2X communications over PC5 reference point.
NOTE 1: In this specification, {When the UE is “served by E-UTRA” or “served by NR”} and {When the UE is “not served by E-UTRA” and “not served by NR”} are relevant to V2X communications over PC5 reference point.
2) Radio parameters when the UE is “not served by E-UTRA” and “not served by NR”:
   Includes the radio parameters per PC5 RAT (i.e. LTE PC5, NR PC5) with Geographical Area(s) and an indication of whether they are “operator managed” or “non-operator managed”. These radio parameters (e.g., frequency bands) are defined in TS 36.331 [14] and TS 38.331 [15]. The UE uses the radio parameters to perform V2X communications over PC5 reference point when “not served by E-UTRA” and “not served by NR” only if the UE can reliably locate itself in the corresponding Geographical Area. Otherwise, the UE is not authorized to transmit.
NOTE 2: Whether a frequency band is “operator managed” or “non-operator managed” in a given Geographical Area is defined by local regulations.
3) Policy/parameters per RAT for PC5 Tx Profile selection:
   The mapping of V2X service types (e.g. PSIDs or ITS-AIDS) to Tx Profiles (see TS 36.300 [9] and TS 38.300 [11] for further information).
4) Policy/parameters related to privacy:
   The list of V2X service types, e.g. PSIDs or ITS-AIDS of the V2X applications, with Geographical Area(s) that require privacy support.
   A privacy timer value indicating the duration after which the UE shall change each source Layer-2 ID self-assigned by the UE when privacy is required.
5) Policy/parameters when LTE PC5 is selected:
   Same as specified in TS 23.285 [8] clause 4.4.1.1.2 item 3) Policy/parameters except for the mapping of V2X service types to Tx Profiles and the list of V2X services with Geographical Area(s) that require privacy support.
6) Policy/parameters when NR PC5 is selected:
   The mapping of V2X service types (e.g. PSIDs or ITS-AIDS) to V2X frequencies with Geographical Area(s).
   The mapping of Destination Layer-2 ID(s) and the V2X service types, e.g. PSIDs or ITS-AIDs of the V2X application for broadcast.
   The mapping of Destination Layer-2 ID(s) and the V2X service types, e.g. PSIDs or ITS-AIDs of the V2X application for groupcast.
   The mapping of default Destination Layer-2 ID(s) for initial signalling to establish unicast connection and the V2X service types, e.g. PSIDs or ITS-AIDS of the V2X application.
NOTE 3: The same default Destination Layer-2 ID for unicast initial signalling can be mapped to more than one V2X service types. In the case where different V2X services are mapped to distinct default Destination Layer-2 IDs, when the UE intends to establish a single unicast link that can be used for more than one V2X service types, the UE can select any of the default Destination Layer-2 IDs to use for the initial signalling.
   PC5 QoS mapping configuration:
      Input from V2X application layer:
         V2X service type (e.g. PSID or ITS-AID).
         (Optional) V2X Application Requirements for the V2X service type, e.g. priority requirement, reliability requirement, delay requirement, range requirement.
NOTE 4: Details of V2X Application Requirements for the V2X service type is up to implementation and out of scope of this specification.
   Output:
      PC5 QoS parameters defined in clause 5.4.2 (i.e. PQI and conditionally other parameters such as MFBR/GFBR, etc.).
   AS layer configurations (see TS 38.331 [15]), e.g. the mapping of PC5 QoS profile(s) to radio bearer(s), when the UE is “not served by E-UTRA” and “not served by NR”.
      The PC5 QoS profile contains PC5 QoS parameters described in clause 5.4.2, and value for the QoS characteristics regarding Priority Level, Averaging Window, Maximum Data Burst Volume if default value is not used as defined in Table 5.4.4-1.
7) Validity timer indicating the expiration time of the V2X Policy/Parameter.
   The above parameter sets from bullet 2) to 6) may be configured in the UE through the V1 reference point by the V2X Application Server.

### 5.2.1.4 Unicast Mode Communication Over PC5 Reference Point

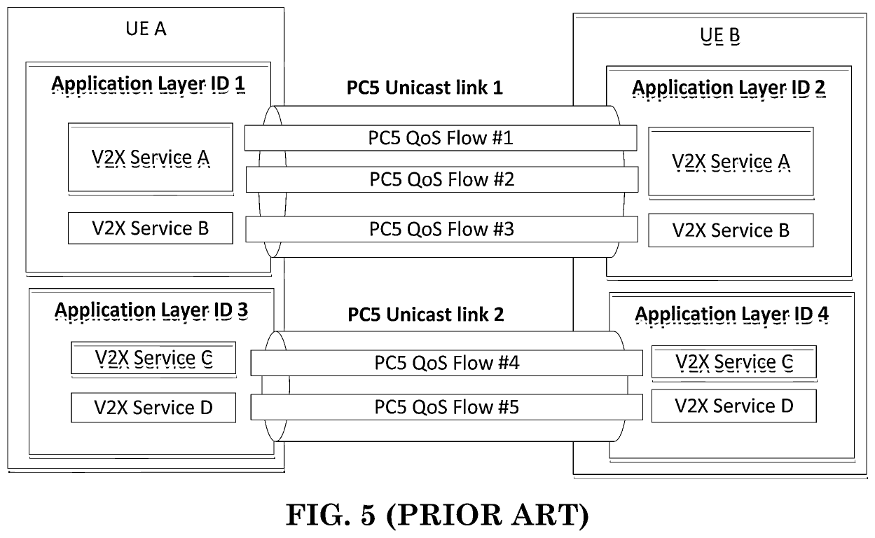

Unicast mode of communication is only supported over NR based PC5 reference point. FIG. 5.2.1.4-1 illustrates an example of PC5 unicast links.

### FIG. 5.2.1.4-1 of 3GPP TS 23.287 V16.2.0, Entitled “Example of PC5 Unicast Links”, is Reproduced as FIG. 5

The following principles apply when the V2X communication is carried over PC5 unicast link:
A PC5 unicast link between two UEs allows V2X communication between one or more pairs of peer V2X services in these UEs. All V2X services in the UE using the same PC5 unicast link use the same Application Layer ID.
NOTE 1: An Application Layer ID can change in time as described in clauses 5.6.1.1 and 6.3.3.2, due to privacy. This does not cause a re-establishment of a PC5 unicast link. The UE triggers a Link Identifier Update procedure as specified in clause 6.3.3.2.
One PC5 unicast link supports one or more V2X service types (e.g. PSIDs or ITS-AIDS) if these V2X service types are at least associated with the pair of peer Application Layer IDs for this PC5 unicast link. For example, as illustrated in FIG. 5.2.1.4-1, UE A and UE B have two PC5 unicast links, one between peer Application Layer ID 1/UE A and Application Layer ID 2/UE B and one between peer Application Layer ID 3/UE A and Application Layer ID 4/UE B.
NOTE 2: A source UE is not required to know whether different target Application Layer IDs over different PC5 unicast links belong to the same target UE.
A PC5 unicast link supports V2X communication using a single network layer protocol e.g. IP or non-IP.
A PC5 unicast link supports per-flow QoS model as specified in clause 5.4.1.
   When the Application layer in the UE initiates data transfer for a V2X service type which requires unicast mode of communication over PC5 reference point:
the UE shall reuse an existing PC5 unicast link if the pair of peer Application Layer IDs and the network layer protocol of this PC5 unicast link are identical to those required by the application layer in the UE for this V2X service, and modify the existing PC5 unicast link to add this V2X service type as specified in clause 6.3.3.4; otherwise
the UE shall trigger the establishment of a new PC5 unicast link as specified in clause 6.3.3.1.
   After successful PC5 unicast link establishment, UE A and UE B use the same pair of Layer-2 IDs for subsequent PC5-S signalling message exchange and V2X service data transmission as specified in clause 5.6.1.4. The V2X layer of the transmitting UE indicates to the AS layer whether a transmission is for a PC5-S signalling message (i.e. Direct Communication Request/Accept, Link Identifier Update Request/Response/Ack, Disconnect Request/Response, Link Modification Request/Accept) or V2X service data.
   For every PC5 unicast link, a UE self-assigns a distinct PC5 Link Identifier that uniquely identifies the PC5 unicast link in the UE for the lifetime of the PC5 unicast link. Each PC5 unicast link is associated with a Unicast Link Profile which includes:
V2X service type(s) (e.g. PSID(s) or ITS-AID(s)); and
Application Layer ID and Layer-2 ID of UE A; and
Application Layer ID and Layer-2 ID of UE B; and
network layer protocol used on the PC5 unicast link; and
for each V2X service type, a set of PC5 QoS Flow Identifier(s) (PFI(s)). Each PFI is associated with QoS parameters (i.e. PQI).
   For privacy reason, the Application Layer IDs and Layer-2 IDs may change as described in clauses 5.6.1.1 and 6.3.3.2 during the lifetime of the PC5 unicast link and, if so, shall be updated in the Unicast Link Profile accordingly. The UE uses PC5 Link Identifier to indicate the PC5 unicast link to V2X Application layer, therefore V2X Application layer identifies the corresponding PC5 unicast link even if there are more than one unicast link associated with one V2X service type (e.g. the UE establishes multiple unicast links with multiple UEs for a same V2X service type).
   The Unicast Link Profile shall be updated accordingly after a Layer-2 link modification for an established PC5 unicast link as specified in clause 6.3.3.4 or Layer-2 link identifier update as specified in clause 6.3.3.2.
   V2X Service Info and QoS Info are carried in PC5-S signalling messages and exchanged between two UEs as specified in clause 6.3.3. Based on the exchanged information, PFI is used to identify V2X service. When the receiving UE receives V2X service data over the established PC5 unicast link, the receiving UE determines the appropriate V2X service based on the PFI to forward the received V2X service data to the upper layer.
   Upon receiving an indication from the AS layer that the PC5-RRC connection was released due to RLF, the V2X layer in the UE locally releases the PC5 unicast link associated with this PC5-RRC connection. The AS layer uses PC5 Link Identifier to indicate the PC5 unicast link whose PC5-RRC connection was released.
   When the PC5 unicast link has been released as specified in clause 6.3.3.3, the V2X layer of each UE for the PC5 unicast link informs the AS layer that the PC5 unicast link has been released. The V2X layer uses PC5 Link Identifier to indicate the released unicast link.

### 5.6.1.4 Identifiers for Unicast Mode V2X Communication Over PC5 Reference Point

For unicast mode of V2X communication over PC5 reference point, the destination Layer-2 ID used depends on the communication peer. The Layer-2 ID of the communication peer, identified by the Application Layer ID, may be discovered during the establishment of the PC5 unicast link, or known to the UE via prior V2X communications, e.g. existing or prior unicast link to the same Application Layer ID, or obtained from application layer service announcements. The initial signalling for the establishment of the PC5 unicast link may use the known Layer-2 ID of the communication peer, or a default destination Layer-2 ID associated with the V2X service type (e.g. PSID/ITS-AID) configured for PC5 unicast link establishment, as specified in clause 5.1.2.1. During the PC5 unicast link establishment procedure, Layer-2 IDs are exchanged, and should be used for future communication between the two UEs, as specified in clause 6.3.3.1.
The Application Layer ID is associated with one or more V2X applications within the UE. If UE has more than one Application Layer IDs, each Application Layer ID of the same UE may be seen as different UE's Application Layer ID from the peer UE's perspective.
The UE maintains a mapping between the Application Layer IDs and the source Layer-2 IDs used for the PC5 unicast links, as the V2X application layer does not use the Layer-2 IDs. This allows the change of source Layer-2 ID without interrupting the V2X applications.
When Application Layer IDs change, the source Layer-2 ID(s) of the PC5 unicast link(s) shall be changed if the link(s) was used for V2X communication with the changed Application Layer IDs. Based on privacy configuration as specified in clause 5.1.2.1, the update of the new identifiers of a source UE to the peer UE for the established unicast link may cause the peer UE to change its Layer-2 ID and optionally IP address/prefix if IP communication is used as defined in clause 6.3.3.2.
A UE may establish multiple PC5 unicast links with a peer UE and use the same or different source Layer-2 IDs for these PC5 unicast links.

### 6.1 Control and User Plane Stacks

### 6.1.1 User Plane for NR PC5 Reference Point Supporting V2X Services

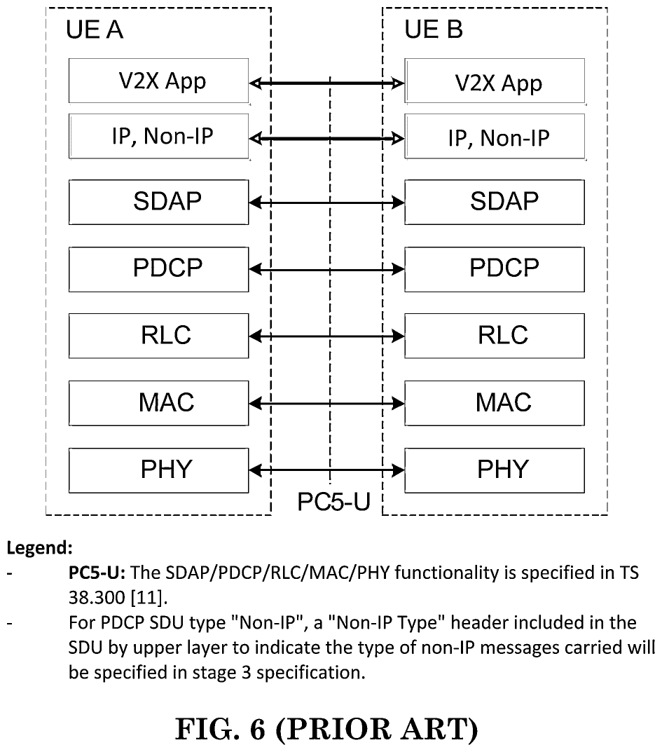

FIG. 6.1.1-1 depicts a user plane for NR PC5 reference point, i.e. PC5 User Plane Protocol stack.

### FIG. 6.1.1-1 of 3GPP TS 23.287 V16.2.0, Entitled “User Plane for NR PC5 Reference Point”, is Reproduced as FIG. 6

IP and Non-IP PDCP SDU types are supported for the V2X communication over PC5 reference point.
For IP PDCP SDU type, only IPv6 is supported. The IP address allocation and configuration are as defined in clause 5.6.1.1.
The Non-IP PDCP SDU contains a Non-IP Type header, which indicates the V2X message family used by the application layer, e.g. IEEE 1609 family's WSMP [18], ISO defined FNTP [19].
NOTE: The Non-IP Type header and allowed values are defined in TS 24.587 [24].
   The packets from V2X application layer are handled by the V2X layer before transmitting them to the AS layer, e.g. V2X layer maps the IP/Non IP packets to PC5 QoS Flow and marks the corresponding PFI.
   6.1.2 Control plane for NR PC5 reference point supporting V2X services
Editor's note: Whether PC5-S messages are carried in PC5 RRC signalling depends on RAN decision.
   FIG. 6.1.2-1 depicts a control plane for NR PC5 reference point, i.e. PC5 Signalling Protocol stack.

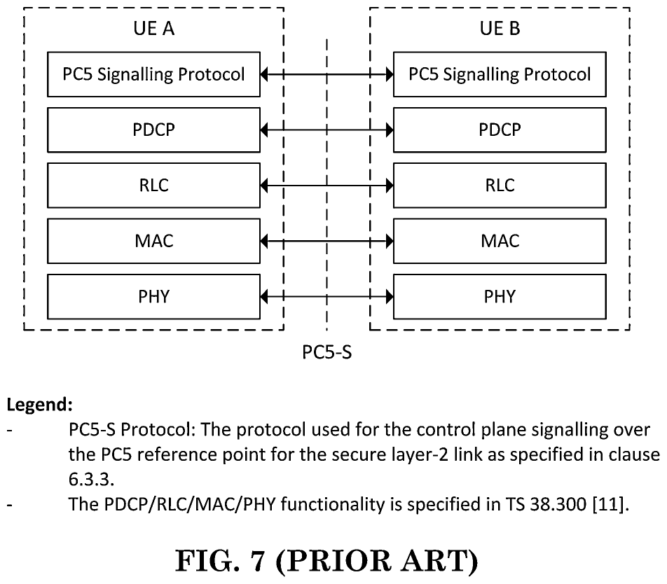

### FIG. 6.1.2-1 of 3GPP TS 23.287 V16.2.0, Entitled “Control Plane for NR PC5 Reference Point”, is Reproduced as FIG. 7

### 6.3.3 Unicast Mode V2X Communication Over PC5 Reference Point

### 6.3.3.1 Layer-2 Link Establishment Over PC5 Reference Point

To perform unicast mode of V2X communication over PC5 reference point, the UE is configured with the related information as described in clause 5.1.2.1.
FIG. 6.3.3.1-1 shows the layer-2 link establishment procedure for unicast mode of V2X communication over PC5 reference point.

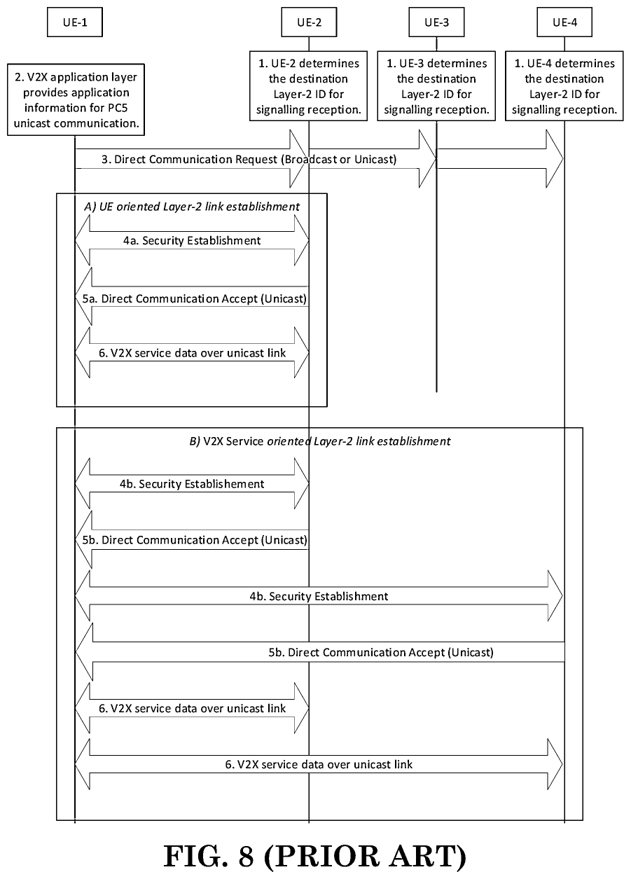

### FIG. 6.3.3.1-1 of 3GPP TS 23.287 V16.2.0, Entitled “Layer-2 Link Establishment Procedure”, is Reproduced as FIG. 8

1. The UE(s) determine the destination Layer-2 ID for signalling reception for PC5 unicast link establishment as specified in clause 5.6.1.4. The destination Layer-2 ID is configured with the UE(s) as specified in clause 5.1.2.1.

2. The V2X application layer in UE-1 provides application information for PC5 unicast communication. The application information includes the V2X service type(s) (e.g. PSID(s) or ITS-AID(s)) of the V2X application and the initiating UE's Application Layer ID. The target UE's Application Layer ID may be included in the application information.

The V2X application layer in UE-1 may provide V2X Application Requirements for this unicast communication. UE-1 determines the PC5 QoS parameters and PFI as specified in clause 5.4.1.4.

If UE-1 decides to reuse the existing PC5 unicast link as specified in clause 5.2.1.4, the UE triggers Layer-2 link modification procedure as specified in clause 6.3.3.4.

3. UE-1 sends a Direct Communication Request message to initiate the unicast layer-2 link establishment procedure. The Direct Communication Request message includes:
Source User Info: the initiating UE's Application Layer ID (i.e. UE-Vs Application Layer ID).
If the V2X application layer provided the target UE's Application Layer ID in step 2, the following information is included:
   Target User Info: the target UE's Application Layer ID (i.e. UE-2's Application Layer ID).
V2X Service Info: the information about V2X Service(s) requesting Layer-2 link establishment (e.g. PSID(s) or ITS-AID(s)).
Security Information: the information for the establishment of security.

NOTE 1: The Security Information and the necessary protection of the Source User Info and Target User Info are defined by SA WG3.
The source Layer-2 ID and destination Layer-2 ID used to send the Direct Communication Request message are determined as specified in clauses 5.6.1.1 and 5.6.1.4. The destination Layer-2 ID may be broadcast or unicast Layer-2 ID. When unicast Layer-2 ID is used, the Target User Info shall be included in the Direct Communication Request message.
UE-1 sends the Direct Communication Request message via PC5 broadcast or unicast using the source Layer-2 ID and the destination Layer-2 ID.

4. Security with UE-1 is established as below:
4a. If the Target User Info is included in the Direct Communication Request message, the target UE, i.e. UE-2, responds by establishing the security with UE-1.
4b. If the Target User Info is not included in the Direct Communication Request message, the UEs that are interested in using the announced V2X Service(s) over a PC5 unicast link with UE-1 responds by establishing the security with UE-1.

NOTE 2: The signalling for the Security Procedure is defined by SA WG3.
When the security protection is enabled, UE-1 sends the following information to the target UE:
   If IP communication is used:
      IP Address Configuration: For IP communication, IP address configuration is required for this link and indicates one of the following values:
         “IPv6 Router” if IPv6 address allocation mechanism is supported by the initiating UE, i.e., acting as an IPv6 Router; or
         “IPv6 address allocation not supported” if IPv6 address allocation mechanism is not supported by the initiating UE.
      Link Local IPv6 Address: a link-local IPv6 address formed locally based on RFC 4862 [21] if UE-1 does not support the IPv6 IP address allocation mechanism, i.e. the IP Address Configuration indicates “IPv6 address allocation not supported”.
   QoS Info: the information about PC5 QoS Flow(s). For each PC5 QoS Flow, the PFI and the corresponding PC5 QoS parameters (i.e. PQI and conditionally other parameters such as MFBR/GFBR, etc.).
The source Layer-2 ID used for the security establishment procedure is determined as specified in clauses 5.6.1.1 and 5.6.1.4. The destination Layer-2 ID is set to the source Layer-2 ID of the received Direct Communication Request message.
Upon receiving the security establishment procedure messages, UE-1 obtains the peer UE's Layer-2 ID for future communication, for signalling and data traffic for this unicast link.

5. A Direct Communication Accept message is sent to UE-1 by the target UE(s) that has successfully established security with UE-1:
5a. (UE oriented Layer-2 link establishment) If the Target User Info is included in the Direct Communication Request message, the target UE, i.e. UE-2 responds with a Direct Communication Accept message if the Application Layer ID for UE-2 matches.
5b. (V2X Service oriented Layer-2 link establishment) If the Target User Info is not included in the Direct Communication Request message, the UEs that are interested in using the announced V2X Service(s) respond to the request by sending a Direct Communication Accept message (UE-2 and UE-4 in FIG. 6.3.3.1-1).
The Direct Communication Accept message includes:
   Source User Info: Application Layer ID of the UE sending the Direct Communication Accept message.
   QoS Info: the information about PC5 QoS Flow(s). For each PC5 QoS Flow, the PFI and the corresponding PC5 QoS parameters requested by UE-1 (i.e. PQI and conditionally other parameters such as MFBR/GFBR, etc).
   If IP communication is used:
      IP Address Configuration: For IP communication, IP address configuration is required for this link and indicates one of the following values:
      “IPv6 Router” if IPv6 address allocation mechanism is supported by the target UE, i.e., acting as an IPv6 Router; or
   “IPv6 address allocation not supported” if IPv6 address allocation mechanism is not supported by the target UE.
Link Local IPv6 Address: a link-local IPv6 address formed locally based on RFC 4862 [21] if the target UE does not support the IPv6 IP address allocation mechanism, i.e. the IP Address Configuration indicates “IPv6 address allocation not supported”, and UE-1 included a link-local IPv6 address in the Direct Communication Request message. The target UE shall include a non-conflicting link-local IPv6 address.
If both UEs (i.e. the initiating UE and the target UE) selected to use link-local IPv6 address, they shall disable the duplicate address detection defined in RFC 4862 [21].

NOTE 3: When either the initiating UE or the target UE indicates the support of IPv6 router, corresponding address configuration procedure would be carried out after the establishment of the layer 2 link, and the link-local IPv6 addresses are ignored.
The V2X layer of the UE that established PC5 unicast link passes the PC5 Link Identifier assigned for the unicast link and the PC5 unicast link related information down to the AS layer. The PC5 unicast link related information includes Layer-2 ID information (i.e. source Layer-2 ID and destination Layer-2 ID). This enables the AS layer to maintain the PC5 Link Identifier together with the PC5 unicast link related information.

6. V2X service data is transmitted over the established unicast link as below:
The PC5 Link Identifier, and PFI are provided to the AS layer, together with the V2X service data.
Optionally in addition, the Layer-2 ID information (i.e. source Layer-2 ID and destination Layer-2 ID) is provided to the AS layer.

NOTE 4: It is up to UE implementation to provide the Layer-2 ID information to the AS layer.
UE-1 sends the V2X service data using the source Layer-2 ID (i.e. UE-1's Layer-2 ID for this unicast link) and the destination Layer-2 ID (i.e. the peer UE's Layer-2 ID for this unicast link).

NOTE 5: PC5 unicast link is bi-directional, therefore the peer UE of UE-1 can send the V2X service data to UE-1 over the unicast link with UE-1.

### 6.3.3.2 Link Identifier Update for a Unicast Link

FIG. 6.3.3.2-1 shows the link identifier update procedure for a unicast link. Due to the privacy requirements, identifiers used for unicast mode of V2X communication over PC5 reference point (e.g. Application Layer ID, Source Layer-2 ID and IP address/prefix) shall be changed over time as specified in clauses 5.6.1.1 and 5.6.1.4. This procedure is used to update and exchange new identifiers between the source and the peer UEs for a unicast link before using the new identifiers, to prevent service interruptions.
If a UE has multiple unicast links using the same Application Layer IDs or Layer-2 IDs, the UE needs to perform the link identifier update procedure over each of the unicast link.

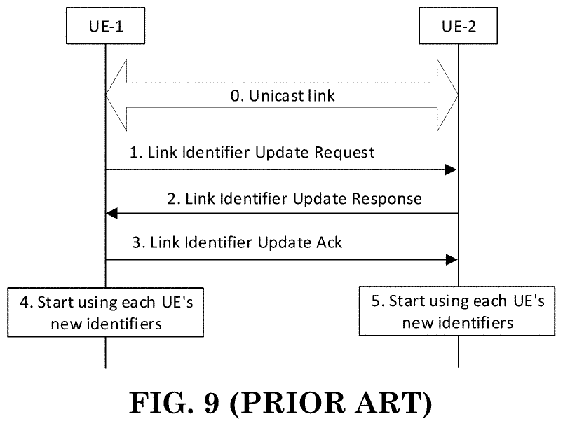

### FIG. 6.3.3.2-1 of 3GPP TS 23.287 V16.2.0, Entitled “Link Identifier Update Procedure”, is Reproduced as FIG. 9

0. UE-1 and UE-2 have a unicast link established as described in clause 6.3.3.1.

1. UE-1 decides to change its identifier(s), e.g. due to the Application Layer ID change or upon expiry of a timer. UE-1 generates its new Layer-2 ID and sends a Link Identifier Update Request message to UE-2 using the old identifiers.
The Link Identifier Update Request message includes the new identifier(s) to use (including the new Layer-2 ID, Security Information, optionally the new Application Layer ID and optionally new IP address/prefix if IP communication is used). The new identifier(s) should be cyphered to protect privacy. After sending the Link Identifier Update request, UE-1 keeps sending data traffic to UE-2 with the old identifiers until UE-1 sends the Link Identifier Update Ack to UE-2.

NOTE 1: The timer is running on per Source Layer-2 ID.

NOTE 2: When one of the two UEs acts as IPv6 router as described in clause 5.2.1.5 and IP address/prefix also need to be changed, corresponding address configuration procedure would be carried out after the Link Identifier update procedure.

2. Upon reception of the Link Identifier Update Request message, based on privacy configuration as specified in clause 5.1.2.1, UE-2 may also decide to change its identifier(s). If UE-2 decides to change its identifier(s), UE-2 responds with a Link Identifier Update Response message which includes the new identifier(s) to use (including the new Layer-2 ID, Security Information, optionally the new Application Layer ID, and optionally a new IP address/prefix if IP communication is used). The new identifier(s) should be cyphered to protect privacy. The Link Identifier Update Response message is sent using the old identifiers. UE-2 continues to receive traffic with the old Layer-2 ID from UE-1 until UE-2 receives traffic with the new Layer-2 ID from UE-1.After sending the Link Identifier Update response, UE-2 keeps sending data traffic to UE-1 with the old identifier until UE-2 receives the Link Identifier Update Ack message from UE-1.

3. Upon reception of the Link Identifier Update Response message, UE-1 responds with a Link Identifier Update Ack message which includes the new identifier(s) from UE-2, as received on the Link Identifier Update Response message. The Link Identifier Update Ack message is sent using the old identifiers. UE-1 continues to receive traffic with the old Layer-2 ID from UE-2 until UE-1 receives traffic with the new Layer-2 ID from UE-2.

4. The V2X layer of UE-1 passes the PC5 Link Identifier for the unicast link and the updated Layer-2 IDs (i.e. new Layer-2 ID for UE-1 for the source and new Layer-2 ID of UE-2 for the destination) down to the AS layer. This enables the AS layer to update the provided Layer-2 IDs for the unicast link.
UE-1 starts using its new identifiers and UE-2's new identifiers for this unicast link.

5. The V2X layer of UE-2 passes the PC5 Link Identifier for the unicast link and the updated Layer-2 IDs (i.e. new Layer-2 ID of UE-2 for the source and new Layer-2 ID for UE-1 for the destination) down to the AS layer. This enables the AS layer to update the provided Layer-2 IDs for the unicast link.
UE-2 starts using its new identifiers and UE-1's new identifiers for this unicast link.

NOTE 3: The Security Information in the above messages also needs to be updated at the same time as the Layer-2 IDs. This is defined in TS 33.536 [26].

### 6.3.3.4 Layer-2 Link Modification for a Unicast Link

FIG. 6.3.3.4-1 shows the layer-2 link modification procedure for a unicast link. This procedure is used to:
add new V2X service(s) to the existing PC5 unicast link.
remove V2X service(s) from the existing PC5 unicast link.
add new PC5 QoS Flow(s) in the existing PC5 unicast link.
modify existing PC5 QoS Flow(s) in the existing PC5 unicast link.
remove existing PC5 QoS Flow(s) in the existing PC5 unicast link.

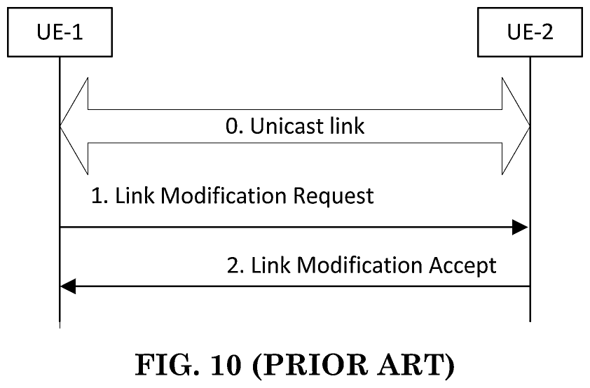

### FIG. 6.3.3.4-1 of 3GPP TS 23.287 V16.2.0, Entitled “Layer-2 Link Modification Procedure”, is Reproduced as FIG. 10

0. UE-1 and UE-2 have a unicast link established as described in clause 6.3.3.1.

1. The V2X application layer in UE-1 provides application information for PC5 unicast communication. The application information includes the V2X service type(s) (e.g. PSID(s) or ITS-AID(s)) of the V2X application(s) and the initiating UE's Application Layer ID. The target UE's Application Layer ID may be included in the application information. If UE-1 decides to reuse the existing PC5 unicast link as specified in clause 5.2.1.4, so decides to modify the unicast link established with UE-2, UE-1 sends a Link Modification Request to UE-2.
The Link Modification Request message includes:
   a) To add new V2X service(s) to the existing PC5 unicast link:
      V2X Service Info: the information about V2X Service(s) to be added (e.g. PSID(s) or ITS-AID(s)).
      QoS Info: the information about PC5 QoS Flow(s) for each V2X Service to be added. For each PC5 QoS Flow, the PFI and the corresponding PC5 QoS parameters (i.e. PQI and conditionally other parameters such as MFBR/GFBR, etc).
   b) To remove a V2X service(s) from the the existing PC5 unicast link:
      V2X Service Info: the information about V2X Service(s) to be removed (e.g. PSID(s) or ITS-AID(s)).
   c) To add new PC5 QoS Flow(s) in the existing PC5 unicast link:
      V2X Service Info: the information about V2X Service(s) that needs to add new QoS Flows (e.g. PSID(s) or ITS-AID(s)).
      QoS Info: the information about PC5 QoS Flow(s) to be modified. For each PC5 QoS Flow, the PFI and the corresponding PC5 QoS parameters (i.e. PQI and conditionally other parameters such as MFBR/GFBR, etc).
   d) To modify PC5 QoS Flow(s) in the existing PC5 unicast link:
      QoS Info: the information about PC5 QoS Flow(s) to be modified. For each PC5 QoS Flow, the PFI and the corresponding PC5 QoS parameters (i.e. PQI and conditionally other parameters such as MFBR/GFBR, etc.).
   e) To remove PC5 QoS Flow(s) in the existing PC5 unicast link:
      PFIs.

2. UE-2 responds with a Link Modification Accept message.
The Link Modification Accept message includes:
   For case a), case c) and case d) described in step 1:
      QoS Info: the information about PC5 QoS Flow(s). For each PC5 QoS Flow, the PFI and the corresponding PC5 QoS parameters (i.e. PQI and conditionally other parameters such as MFBR/GFBR, etc).
The V2X layer of each UE provides information about the unicast link modification to the AS layer. This enables the AS layer to update the context related to the modified unicast link.

3GPP TS 38.323 specifies ciphering/deciphering function and Packet Data Convergence Protocol (PDCP) Data Protocol Data Unit (PDU) format for Signaling Radio Bearers (SRBs) as follows:

### 5.8 Ciphering and Deciphering

The ciphering function includes both ciphering and deciphering and is performed in PDCP, if configured. The data unit that is ciphered is the MAC-I (see clause 6.3.4) and the data part of the PDCP Data PDU (see clause 6.3.3) except the SDAP header and the SDAP Control PDU if included in the PDCP SDU. The ciphering is not applicable to PDCP Control PDUs.
For downlink and uplink, the ciphering algorithm and key to be used by the PDCP entity are configured by upper layers TS 38.331 [3] and the ciphering method shall be applied as specified in TS 33.501 [6].
The ciphering function is activated/suspended/resumed by upper layers TS 38.331 [3]. When security is activated and not suspended, the ciphering function shall be applied to all PDCP Data PDUs indicated by upper layers TS 38.331 [3] for the downlink, the uplink, and the sidelink, respectively.
For DAPS bearers, the PDCP entity shall perform the ciphering or deciphering for the PDCP SDU using the ciphering algorithm and key either configured for the source cell or configured for the target cell, based on to/from which cell the PDCP SDU is transmitted/received.
For downlink and uplink ciphering and deciphering, the parameters that are required by PDCP for ciphering are defined in TS 33.501 [6] and are input to the ciphering algorithm. The required inputs to the ciphering function include the COUNT value, and DIRECTION (direction of the transmission: set as specified in TS 33.501 [6]). The parameters required by PDCP which are provided by upper layers TS 38.331 [3] are listed below:
BEARER (defined as the radio bearer identifier in TS 33.501 [6]. It will use the value RB identity-1 as in TS 38.331 [3]);
KEY (the ciphering keys for the control plane and for the user plane are K_{RRCenc} and K_{UPenc}, respectively).
   For NR sidelink communication, the ciphering function as specified in TS 33.501 [6] is applied with KEY (PEK), COUNT, BEARER and DIRECTION (which value shall be set is specified in TS 33.536 [14]) as input.

### 6.2.2.1 Data PDU for SRBs

FIG. 6.2.2.1-1 shows the format of the PDCP Data PDU with 12 bits PDCP SN. This format is applicable for SRBs.

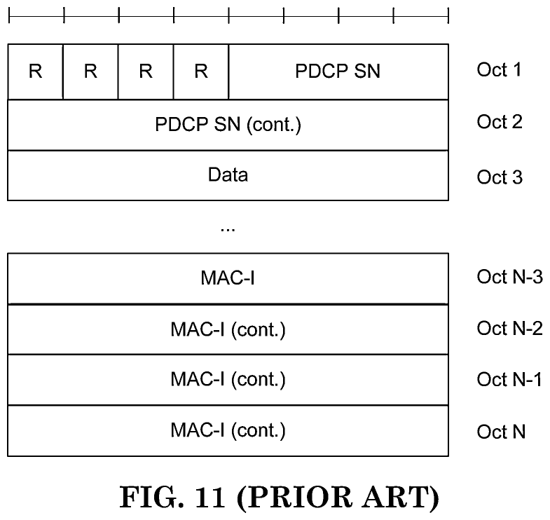

### FIG. 6.2.2.1-1 of 3GPP TS 38.323 V16.0.0, Entitled “PDCP Data PDU Format for SRBs”, is Reproduced as FIG. 11

3GPP TS 38.331 specifies multiple sidelink SRBs are established for transmitting PC5-RRC signalling (or messages) and PC5-S messages as follows:

### 5.8 Sidelink

### 5.8.1 General

NR sidelink communication consists of unicast, groupcast and broadcast. The PC5-RRC connection is a logical connection between a pair of a Source Layer-2 ID and a Destination Layer-2 ID in the AS. The PC5-RRC signalling, as specified in sub-clause 5.8.9, can be initiated after its corresponding PC5 unicast link establishment (TS 23.287 [55]). The PC5-RRC connection and the corresponding sidelink SRBs and sidelink DRBs are released when the PC5 unicast link is released as indicated by upper layers.
For each PC5-RRC connection of unicast, one sidelink SRB is used to transmit the PC5-S messages before the PC5-S security has been established. One sidelink SRB is used to transmit the PC5-S messages to establish the PC5-S security. One sidelink SRB is used to transmit the PC5-S messages after the PC5-S security has been established, which is protected. One sidelink SRB is used to transmit the PC5-RRC signalling, which is protected and only sent after the PC5-S security has been established.

3GPP TR 23.752 introduces the issue on support of UE-to-UE Relay and related solutions for a new release (i.e. Release 17) as follows:

### 5.4 Key Issue #4: Support of UE-to-UE Relay

### 5.4.1 General Description

This key issue intends to support for UE-to-UE Relay, including support for in coverage and out of coverage operation.
At least the following aspects need to be considered in potential solutions:
How to (re)-select a UE-to-UE Relay UE in proximity?
Whether and how for the network can control the UE-to-UE Relay operation, at least including how to:
   Authorize the UE-to-UE Relay, e.g. authorize a UE as UE-to-UE Relay?
   Provide the visibility of source/target UE and the UE-to-UE Relay to the network for the purpose of, e.g. charging?
How to establish the connection between the source UE and the target UEs via UE-to-UE Relay?
How to provide end-to-end QoS framework to satisfy the QoS requirements (such as data rate, reliability, latency)?
How to enhance the system architecture to provide the security protection for relayed connection?
How to provide a mechanism for path changing in case of e.g. UE-to-UE Relay changes?

NOTE 1: For the involvement of NG-RAN, coordination with RAN WGs is needed.

NOTE 2: For security aspects, coordination with SA3 is needed.

6.9 Solution #9: Connection establishment via UE-to-UE Layer-2 Relay

### 6.9.1 Description

### 6.9.1.1 General

Using the solution described in this clause, a UE-to-UE Relay enables the discovery of a source UE by a target UE. A UE-to-UE Relay is authorized to relay messages between two UEs over the PC5 interface via authorization and provisioning, as defined in clause 6.Y Solution for Key Issue #4: UE-to-UE Relay Authorization and Provisioning.
The source UE announces its supported applications or discovers a target UE using a known discovery mechanism, e.g. using user-oriented or service-oriented methods as defined in TS 23.287 [5].
The UE-to-UE Relay listens for ProSe applications advertisements (e.g. Direct Discovery or Direct Communication Request messages) from surrounding UEs and if a broadcasted application matches one of the applications from its provisioned relay policy/parameters, the UE-to-UE Relay advertises it as a relayed application by adding a relay indication to the message.
A target UE discovers a source UE via a UE-to-UE Relay. The target UE receives a broadcast Direct Communication Request message with a relay indication.
A secured “extended” PC5 link is set up between the source UE and the target UE via the UE-to-UE Relay. The source/target UEs do not know their respective peer UE's L2 IDs. Source/Target UEs send messages to the UE-to-UE Relay and receive messages through the UE-to-UE Relay. However, the security association and the PC5 unicast link are established directly between the source UE and target UE. The UE-to-UE Relay forwards the messages in opaque mode, without the ability to read, modify their content or replay them. The source/target UEs detect that the link establishment is going through a UE-to-UE Relay upon detecting a relay indication included in the received messages.
The UE-to-UE Relay assigns itself two Relay-L2 IDs when a unicast link is established between two peer UEs via the UE-to-UE Relay. The first Relay-L2 ID is used when forwarding a message to the target UE. The second Relay-L2 ID is used when forwarding a message to the source UE. The UE-to-UE Relay maintains a mapping table containing the mapping of peer UEs L2 IDs and the corresponding Relay-L2 IDs that have been self-assigned. When receiving a message, the UE-to-UE Relay uses its mappings table to find the source and destination IDs to be used to forward the message to the target UE. The UE-to-UE Relay uses the Relay-L2 ID specified in the destination field to find the related UE and uses the UE's L2 ID specified in the source field to find the related Relay-L2 ID. It then updates the source and destination fields of the received message with its corresponding UE's L2 ID and Relay-L2 ID before forwarding the message.
NOTE: Additional security-related parameters and procedures may be needed for the protection of relay related messages. Their definitions need to be coordinated with SA WG3.
   Link management (i.e. keepalive, link modification, link identifier update and link release) is supported over direct unicast links and needs to be supported over extended PC5 links as well.
   Since the security association of extended PC5 links is between the peer UEs, all messages sent over the extended PC5 link, including link management (i.e. PC5-S) messages, may only be processed by those two UEs.
   Having the PC5 link management messages processed by the peer UE is not a problem for most of the management functionality. For the keepalive functionality, both UEs may send/receive keepalive messages and validate that the extended link is still alive. For the link modification, that is used to add or remove QoS flows or services or modify QoS flows, it needs to be applied to the extended link and handled by the two peer UEs. For the link release, the peer UEs may exchange the release messages and then inform the UE-to-UE Relay (i.e. using the management link as defined in clause 6.9.2.2) to allow it to clean-up its mapping table.
   As for the link identifier update procedure, the peer UEs cannot update their Layer-2 IDs transparently to the UE-to-UE Relay. The reason is that the UEs do not know their peer's Layer-2 ID since they are addressing their outgoing messages to the UE-to-UE Relay Layer-2 ID. The UE-to-UE Relay uses the Layer-2 IDs of the peer UEs for relaying purposes, thus the UE-to-UE Relay must be informed of the updated Layer-2 ID from both peer UEs. Additionally, the UE-to-UE Relay must change its Layer-2 IDs, associated to the extended link, whenever the peer UEs change their Layer-2 IDs since the UE-to-UE Relay L2 IDs used for this unicast link are visible in the header thus may be used to link the UEs old Layer-2 IDs with their new Layer-2 IDs. In summary, when the initiating UE changes its identifiers (e.g. Layer-2 ID and security info), the UE-to-UE Relay needs to update its Layer-2 ID used on the unicast link with the initiating UE and since the security info (established between the two peers UEs) is also updated, the identifiers used over the unicast link between the UE-to-UE Relay and the target UE also need to be updated.
   To update identifiers used for unicast communication via a UE-to-UE Relay, i.e. for an extended unicast link, a “management” unicast link is established between each UE and the UE-to-UE Relay. This management link is secured (i.e. integrity and confidentiality protected) between the UE and the UE-to-UE Relay. It is used to manage extended links associated to the same UE-to-UE Relay as the management link. If multiple UE-to-UE Relays are used to reach peer UEs then multiple managements links may be created by a UE, e.g. one toward each UE-to-UE Relay.
   Existing Link Identifier Update messages sent to the UE-to-UE Relay are modified to include additional information needed by the UE-to-UE Relay to identify the extended unicast link to which these messages apply. The additional information includes: 1) “extended link” indication, 2) UE's current Layer-2 ID used on extended link, 3) UE's new Layer-2 ID for extended link, 4) UE-to-UE Relay's Layer-2 ID used on extended link.
   A management link may be released once the link identifier update procedure is completed, or it may be kept. If it is kept then it is treated like any other PC5 unicast link, i.e. its Layer-2 IDs need to be updated periodically, keepalive may be exchanged, etc.

### 6.9.1.2 Control and User Plane Protocol Stacks

FIG. 6.9.1.2-1 illustrates control plane protocol stacks using a UE-to-UE Layer-2 Relay. UE-to-UE Layer-2 Relay uses self-generated own Layer-2 IDs inserted as source Layer-2 ID in the already formed L2 frames relayed between UE1 and UE2. L2 frames are forwarded based on mapped UE1 Layer-2 ID, UE2 Layer-2 ID. The signalling messages are transparently transferred between UE1 and UE2 over UE-to-UE Layer-2 Relay without any modification other than the source and destination Layer-2 IDs. The security is established end to end between UE1 and UE2 as shown by the PDCP layer terminating in UE1 and UE2.

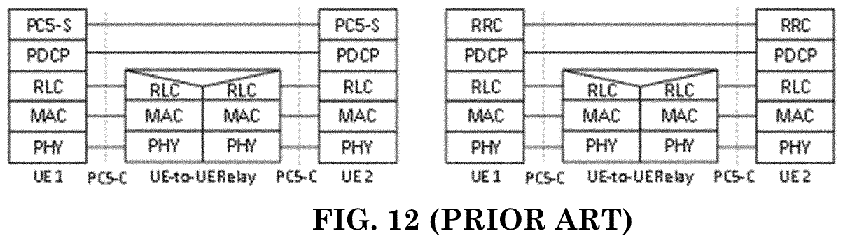

### FIG. 6.9.1.2-1 of 3GPP TR 23.752 V0.4.0, Entitled “Control Plane Protocol Stacks for PC5 Using a UE-to-UE Layer-2 Relay”, is Reproduced as FIG. 12

FIG. 6.9.1.2-2 illustrates user plane protocol stacks using a UE-to-UE Layer-2 Relay. As for the control plane, the security is established end to end between UE1 and UE2. Therefore, user data is never exposed at the relay node since the relay function does not process/apply any security on relayed IP packets.

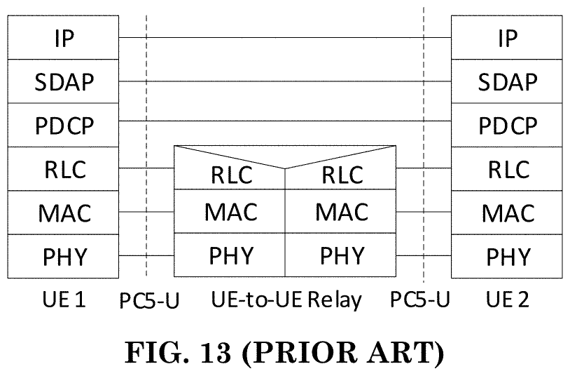

### FIG. 6.9.1.2-2 of 3GPP TR 23.752 V0.4.0, Entitled “User Plane Protocol Stacks Using a UE-to-UE Layer-2 Relay”, is Reproduced as FIG. 13

The SDAP and PDCP protocols above are as specified in TS 38.300 [11].
Editor's note: The proposed protocol stacks are to be confirmed with RAN WG2.

### 6.9.2 Procedures

### 6.9.2.1 Connection Establishment

The two methods defined in TS 23.287 [5], i.e. service-oriented and user-oriented are supported using the procedure described in this clause.
FIG. 6.9.2-1 shows the peer discovery and unicast link establishment over PC5 reference point via a UE-to-UE Relay.

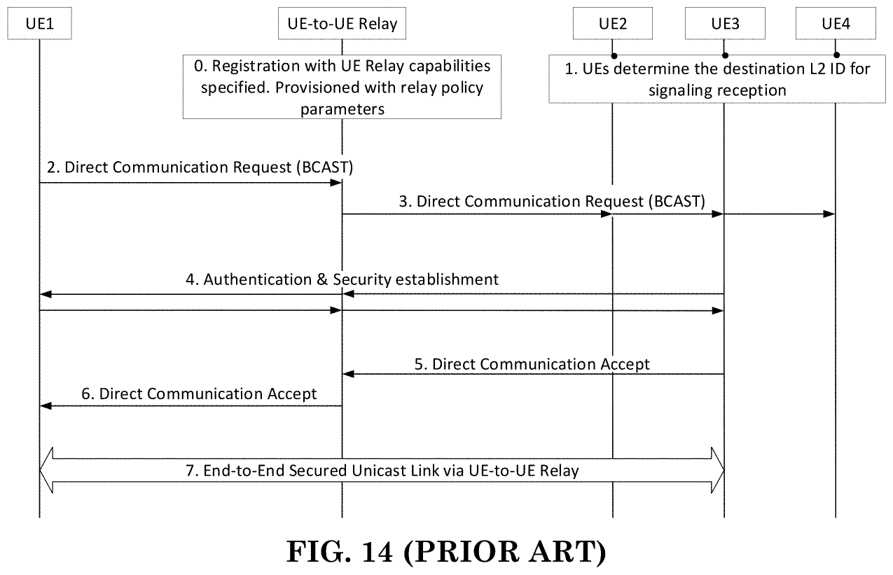

### FIG. 6.9.2-1 of 3GPP TR 23.752 V0.4.0, Entitled “Connection Establishment Procedure Via a UE-to-UE Relay”, is Reproduced as FIG. 14

0. UE-to-UE Relay registers with the network and specifies its UE-to-UE Relay capabilities. UE-to-UE Relay is provisioned from the network with relay policy parameters and with a unique Relay identifier (RID).

1. The target UEs (i.e. UE2, UE3 and UE4) determine the destination Layer-2 ID for signalling reception for PC5 unicast link establishment as specified in TS 23.287 [5] clause 5.6.1.4. The destination Layer-2 ID is configured with the target UEs as specified in TS 23.287 [5] clause 5.1.2.1.
On the source UE (i.e. UE1), the application layer provides information to the ProSe layer for PC5 unicast communication (e.g. broadcast Layer-2 ID, ProSe Application ID, UE's Application Layer ID, target UE's Application Layer ID, relay applicable indication), as specified in TS 23.287 [5] clause 6.3.3.1.

3. ProSe layer triggers the peer UE discovery mechanism by sending a broadcast Direct Communication Request message. The message is sent using the source Layer-2 ID and broadcast Layer-2 ID as destination, and includes other parameters related to the application offered, as specified in TS 23.287 [5] clause 6.3.3.1. Optionally, ProSe Application Code obtained from 5G DDNMF via the solution for KI #1 is also included in the message.
The UE-to-UE Relay receives the broadcast Direct Communication Request message and verifies if it's configured to relay this application, i.e. it compares the announce ProSe Application ID with its provisioned relay policy/parameters and, if it matches, the UE-to-UE Relay assigns itself a Relay-Layer-2 ID (e.g. R-L2 ID-a) for UE1 (i.e. related to UE1's L2 ID).
   These 2 IDs (UE1's Layer-2 ID and Relay-Layer-2 ID-a) are saved in a local mapping table. The UE-to-UE Relay overrides the source field of the message with its R-L2 ID-a and adds its unique relay identifier (RID) as a relay indication. This relay indication is added by the UE-to-UE Relay only on broadcast messages since these messages are sent in clear text (i.e. without any encryption or integrity protection) thus may be modified. The UE-to-UE Relay proceeds in forwarding the broadcast Direct Communication Request message received from the source UE.

4. Target UE3 is interested in the announced application or it can match the ProSe Application Code contained in the request message thus, it triggers the authentication and security establishment with UE1, via the UE-to-UE Relay. UE3 keeps track of the Relay's identifiers, i.e. R-L2 ID-a and RID. UE3 sends the RID in a security protected message during the authentication and security establishment to inform UE1 that the communication is traversing the UE-to-UE Relay identified by RID.

UE-to-UE Relay receives the message from UE3 and uses the R-L2 ID-a specified in the destination field to find the related UE (i.e. UE1 in this case) in its mapping table.
UE-to-UE Relay assigns itself a new Layer-2 ID (e.g. R-L2 ID-b) for UE3 and stores the mapping between UE3's L2 ID and R-L2 ID-b.
UE-to-UE Relay sets the source field of the message to R-L2 ID-b and sets the destination field to UE1's Layer-2 ID (i.e. L2 ID1) retrieved from the mapping entry. UE-to-UE Relay sends the message to UE1.
UE1 receives the authentication message and keeps track of R-L2 ID-b and RID. R-L2 ID-b is used as the destination on subsequent messages destined to UE3 and sent via the UE-to-UE Relay. Authentication and security establishment messages are exchanged between UE1 and UE3 via the UE-to-UE Relay. UE-to-UE Relay changes the source/destination Layer-2 IDs based on the information saved in its local mapping table.

Editor's note: The Details of the authentication and security procedure will be investigated by SA WG3 group.

5. Once the security is established, UE3 completes the unicast link establishment by sending a Direct Communication Accept message.

6. UE-to-UE Relay receives the message and sets the source field of the message to the R-L2 ID-b as found in the mapping entry and sets the destination field to the UE1's L2 ID also from the mapping entry. UE-to-UE Relay sends the modified message to UE1.

7. An “extended” unicast link is established between UE1 and UE3, via the UE-to-UE Relay. The extended link is secured end to end, i.e. a security association has been created between UE1 and UE3. Confidentiality and/or integrity/replay protected messages (i.e. data or PC5-S) may be exchanged between UE1 and UE3. The UE-to-UE Relay is not involved in the security association thus it cannot read nor modify the secured portion of the message (which excludes the source and destination fields).

In addition, the UE-to-UE Layer-2 Relay operation is also supported with the following principles:
UE-to-UE Relay selection.
   It may be the situation where multiple UE-to-UE relays can be used to achieve the indirect communication between the target UE and source UE. The selection of the UE-to-UE Relay may be based on local configured rules on the UE, or based on other UE-to-UE Relay selection solutions, e.g. “UE-to-UE Relay Selection Without Relay Discovery” described in clause 6.8.
QoS handling.
   During the process of the connection establishment between the Source UE1 and the Target UE3, the Source UE1 negotiates the PC5 QoS parameters with the UE-to-UE Relay UE and Target UE3 for fulfilling E2E QoS requirements. After that, PC5 QoS parameters for PC5 link between the Source UE and UE-to-UE Relay UE and PC5 link between the UE-to-UE Relay UE and Target UE are determined. AS layer configurations for PC5 QoS parameters in each PC5 link can be achieved according to legacy mechanisms in R16 V2X.
   QoS flow concept in particular can be reused between the Source UE and the Target UE, where the UE-to-UE Relay UE performs the necessary adaptation between two PC5 interfaces, i.e. PC5 for the Source UE and UE-to-UE Relay UE and PC5 for the UE-to-UE Relay UE and Target UE.

Editor's note: The details of the adaptation between two PC5 interfaces are confirmed by RAN WG2.
Charging support.
   The charging for Source UE and Target UE can be based on charging usage information configuration and UE reporting usage information. Solution for charging usage information configuration can reuse the PCF based solution, i.e., Solution #14. Solution for UE reporting usage information can reuse SMF based or AMF based solution, i.e., Solution #13 or Solution #15.

### 6.9.2.2 Connection Management

6.9.2.2 Link Identifier Update Via a Management Link with the UE-to-UE Relay
FIG. 6.9.2.2-1 shows the link identifier update procedure when an extended PC5 link is used. The procedure uses a management link established between UE1 and the UE-to-UE Relay serving this extended link and another management link established between UE2 and the same UE-to-UE Relay.

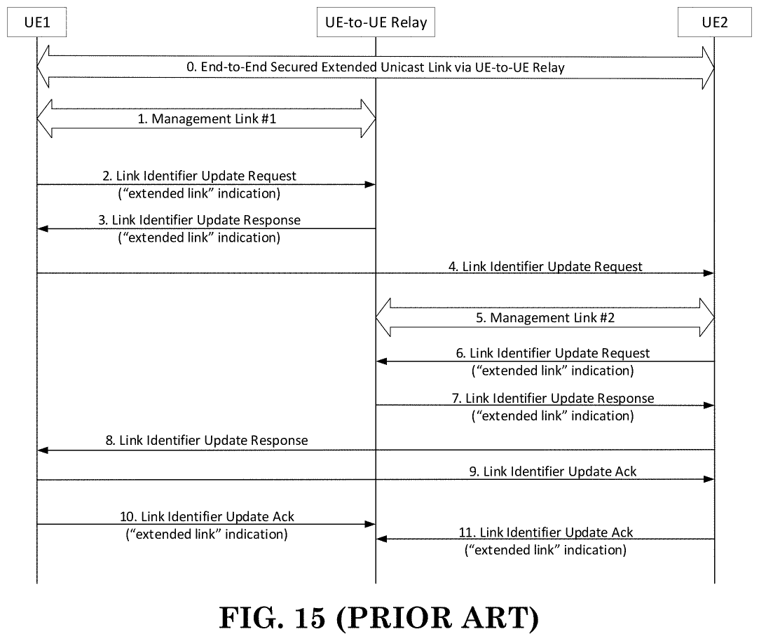

### FIG. 6.9.2.2-1 of 3GPP TR 23.752 V0.4.0, Entitled “Link Identifier Update Procedure Via a Management Link with a UE-to-UE Relay”, is Reproduced as FIG. 15

0) An “extended” unicast link is established between two peer UEs via a UE-to-UE Relay, i.e. as described in clause 6.9.2.1 with end-to-end security enabled.

1) UE1 receives a trigger (e.g. privacy timer expiry or Application Layer ID change) to update its identifiers (i.e. Layer-2 ID, security information, Application Layer ID or IP address/prefix) associated to the extended link with UE2. UE1 establishes a secured unicast link with the UE-to-UE Relay for link management purposes, if such a link is not already established.

2) UE1 updates its identifiers (i.e. Layer-2 ID, security information and optionally Application Layer ID and IP address/prefix) and sends a Link Identifier Update Request message to the UE-to-UE Relay via the management link. The message includes UE1's new Layer-2 ID and an indication (e.g. “extended link” indication) which specifies that the message is related to an extended link, i.e. it does not apply to the management link per se. The message also includes the UE-to-UE Relay's Layer-2 ID and UE1's Layer-2 ID used to identify the extended link.
a. Other identifiers (i.e. security info, Application Layer ID and IP address/prefix) are not included since they are not used by the UE-to-UE Relay and should not be exposed to the UE-to-UE Relay.

3) UE-to-UE Relay saves UE1's new Layer-2 ID in its mapping table, while preserving the current one, and updates its own Layer-2 ID to replace the current UE-to-UE Relay L2 ID used on the extended link and known by UE2. It replies with Link Identifier Update Response message including its new UE-to-UE Relay Layer-2 ID and the “extended link” indication.

4) UE1 sends a Link Identifier Update Request message to UE2 including the new UE-to-UE Relay L2 ID received at step 3, UE1's updated security information and optionally new Application Layer ID and IP address/prefix.
a. The Link Identifier Update Request message is used as usual, except for the new L2 ID parameter that carries the new UE-to-UE Relay L2 ID to be used by UE2.

5) UE2 keeps track of the received parameters and establishes a secured unicast link with the UE-to-UE Relay for extended unicast link management, if no such management link already exists.

6) As for UE1 in step 2, UE2 updates its identifiers associated to the extended link with UE1 and sends a Link Identifier Update Request message to UE-to-UE Relay via the management link. The Link Identifier Update Request message includes the “extended link” indication, the current UE-to-UE Relay's Layer-2 ID and UE2's Layer-2 ID (to identify the extended link) as well as UE2's new Layer-2 ID associated to the extended link.

7) UE-to-UE Relay saves UE2's new Layer-2 ID in its mapping table, while preserving the current one, and updates its own Layer-2 ID to replace the current UE-to-UE Relay L2 ID used on the extended link and known by UE1. It replies with Link Identifier Update Response message including its new UE-to-UE Relay Layer-2 ID and the “extended link” indication.

8) UE2 sends a Link Identifier Update Response message to UE1 including the new UE-to-UE Relay L2 ID received at step 7, UE2's updated security information and optionally new Application Layer ID and IP address/prefix. UE2 also includes the parameters received on the Link Identifier Update Request message at step 4.

9) UE1 keeps track of the received updated parameters from UE2 and sends a Link Identifier Update Ack message to UE2, including the parameters received on the Link Identifier Update Response message at step 8.

10) UE1 sends a Link Identifier Update Ack message to the UE-to-UE Relay, including the new UE-to-UE Relay Layer-2 ID received at step 3 and the “extended link” indication.
UE2 sends a Link Identifier Update Ack message to the UE-to-UE Relay, including the new UE-to-UE Relay Layer-2 ID received at step 7 and the “extended link” indication. All UEs (i.e. UE1, UE2 and UE-to-UE Relay) start using the new Layer-2 IDs, new security information and optionally new Application Layer ID and new IP address/prefix.

### 6.9.3 Impacts on Services, Entities and Interfaces

The solution has impacts in the following entities:

### UE:

Needs to support procedures for ProSe 5G UE-to-UE Relay and communications via a ProSe 5G UE-to-UE Relay.
Needs to support procedures for extended communication management, via communication with a ProSe 5G UE-to-UE Relay.

### 6.31 Solution #31: QoS Control for UE-to-UE Relay

### 6.31.1 Description

This is a solution for Key Issue #4, UE-to-UE Relay. This solution is applicable for both Layer 2 UE-to-UE Relay and Layer 3 UE-to-UE Relay.
When a source UE wants to establish unicast communication with a target UE, the source UE will decide the E2E QoS parameters between source UE and target UE based on the application layer requirements. The E2E QoS parameters, especially the PDB, needs to be split between the two PC5 interface. The PER of the two PC5 interfaces also needs to be set properly to achieve the PER target in the E2E QoS parameters.
Relay will split the E2E QoS parameters into two parts: one part is the QoS parameters between source UE and Relay (we call it “Source side PC5 QoS parameters”), the other part is the QoS parameters between Relay and the target UE (we call it “Target side PC5 QoS parameters”). When standardized PQI is used, the Source side PC5 QoS parameters and the Target side PC5 QoS parameters include PQI and other optional QoS parameters, e.g. GFBR. When non-standardized PQI is used, the whole set of PC5 QoS characteristics is also included.
Relay ensures the PDB and PER associated with the PQI in the Source side PC5 QoS parameters and the PDB and PER associated with the PQI in the Target side PC5 QoS parameters supports the E2E PDB requirements between Remote UE and target UE. Relay also ensures other QoS parameters/QoS characteristics in the Source side PC5 QoS parameters and Target side PC5 QoS parameters are compatible, e.g. have the same value. The Relay decision may be based on the local policy or the low layer measurement.
Optionally, it's possible that the source UE is pre-configured with authorized service(s) and the related Source side PC5 QoS parameters, the UE-to-UE Relay is pre-configured with authorized service(s) and the related Target side PC5 QoS parameters. These can be provided by PCF during provisioning procedure. The authorized service can be identified by Relay Service Code etc. With the preconfigured QoS parameters, the source UE provides the Source side PC5 QoS parameters to the UE-to-UE Relay by the procedure defined in TS 23.287 [5] clause 6.3.3.1 or 6.3.3.4, then the UE-to-UE Relay identifies the authorized service and establishes the corresponding PC5 QoS Flows with the Target UE using the preconfigured Target side PC5 QoS parameters.
E2E QoS parameters splitting is common for both Layer 2 UE-to-UE Relay and Layer 3 UE-to-UE Relay. The difference lies in the QoS flow. In the Layer 3 UE-to-UE Relay case, two QoS flows are setup, one QoS flow between Source UE and UE-to-UE Relay UE, and another QoS flow between Source UE and UE-to-UE Relay UE. In the Layer 2 UE-to-UE Relay case, the end-to-end QoS flow is setup between the Source UE and the Target UE.

### 6.31.2 Procedures for Layer 3 UE-to-UE Relay

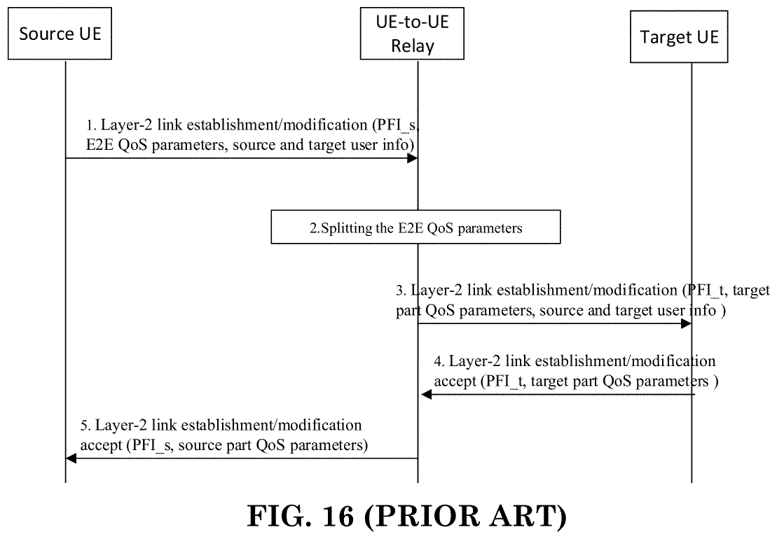

### FIG. 6.31.2-1 of 3GPP TR 23.752 V0.4.0, Entitled “QoS Control for Layer 3 UE-to-UE Relay”, is Reproduced as FIG. 16

1. Source UE wants to establish unicast communication with target UE, it decides the E2E QoS parameters between source UE and target UE based on the application layer requirements. The Source UE sets up a PC5 QoS Flow with PFI=PFI_s. Then Source UE provides the PFI_s, E2E QoS parameters, source and target user info to UE-to-UE Relay. The process is similar to the unicast L2 link establishment or modification procedure as defined in TS 23.287 [5] clause 6.3.3.

2. Relay splits the E2E QoS parameters into two parts: one part is for the PC5 interface between source UE and Relay, the other part is for the PC5 interface between Relay and the target UE. Relay will setup a PC5 QoS Flow with PFI=PFI_t using the target side PC5 QoS parameters between Relay and the target UE.

3. Relay provides the PFI_t, target side PC5 QoS parameters, source and target user info to target UE. The process is similar to the unicast L2 link establishment or modification procedure as defined in TS 23.287 [5] clause 6.3.3.

4. Relay receives the Layer-2 link establishment/modification accept from target UE.

5. Relay provides the Layer-2 link establishment/modification accept to the source UE with the PFI_s and the source side PC5 QoS parameters.

The data transfer on Layer 3 UE-to-UE Relay is according to traffic filter on both hops.

### 6.31.3 Procedures for Layer 2 UE-to-UE Relay

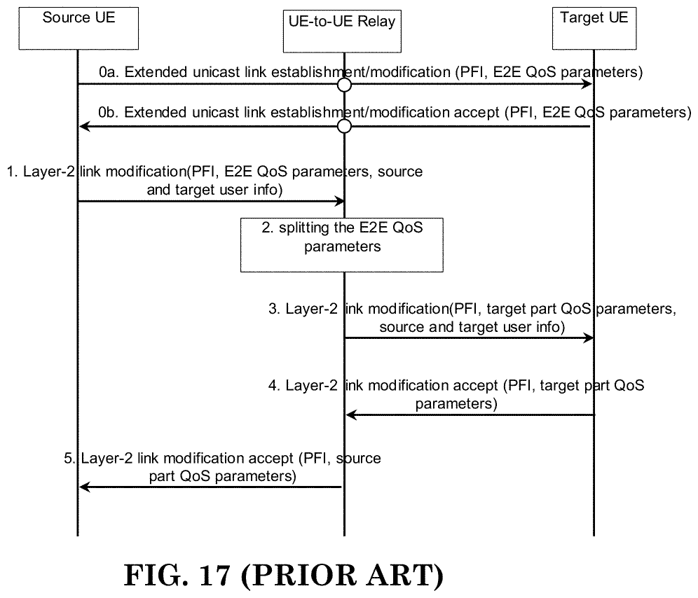

### FIG. 6.31.3-1 of 3GPP TR 23.752 V0.4.0, Entitled “QoS Control for Layer 2 UE-to-UE Relay”, is Reproduced as FIG. 17

0. When the Source UE wants to communication with the target UE, it uses the extended unicast link defined in Solution #9, and the Source UE decides the E2E QoS parameters between Source UE and Target UE based on the application layer requirements. The Source UE sets up a PC5 QoS Flow with PFI, similar to the V2X mechanism defined in clause 6.3.3.1 of TS 23.287 [5], the Source UE negotiates the information about PC5 QoS Flow, which includes the PFI, the corresponding E2E PC5 QoS parameters and the associated application info, with the Target UE in step 0a and step 0b. In this step, E2E PC5-S messages are used for E2E QoS negotiation, and the UE-to-UE Relay just transfers the E2E PC5-S messages using the RAN specified L2 relay method.

NOTE: The PC5-S messages used in step 0 are the E2E PC5-S messages transferred between the Source UE and the Target UE and the PC5-S messages used in step 1 to step 5 are the per-hop PC5-S messages transferred between the Source UE or the Target UE and the UE-to-UE Relay.

1. After the E2E QoS parameter negotiation in step 0a and step 0b, the Source UE provides the PFI, E2E QoS parameters, source and target user info to UE-to-UE Relay. The process is similar to the unicast L2 link establishment or modification procedure as defined in TS 23.287 [5] clause 6.3.3.

2. Relay splits the E2E QoS parameters into two parts: one part is for the PC5 interface between source UE and Relay (source side PC5 QoS parameters), the other part is for the PC5 interface between Relay and the target UE (target side PC5 QoS parameters).

3. Relay provides the PFI received from source UE, target side PC5 QoS parameters, source and target user info to target UE. The process is similar to the unicast L2 link establishment or modification procedure as defined in TS 23.287 [5] clause 6.3.3.

4. Relay receives the Layer-2 link establishment/modification accept from target UE.

5. Relay provides the Layer-2 link establishment/modification accept to the source UE with the PFI and the source side PC5 QoS parameters.

After the PC5 QoS parameters splitting for two PC5 links, the AS layer configurations for PC5 QoS parameters in each of the PC5 links can be achieved according to legacy mechanisms in Rel-16 V2X (TS 23.287 [5]). For the QoS enforcement, the UE-to-UE Relay UE performs the necessary adaptation in the AS layers of the two PC5 interfaces, and it transfers the received data based on the adaptation in the AS layer.

Editor's note: How to ensure the PC5 QoS over the two PC5 links by the Adaptation Layer, and the functionalities of the Adaptation Layer will be confirmed by RAN WG2.

If the Source UE or Target UE wants to add, remove or modify a QoS flow on the extended unicast link, the link modification procedure defined in clause 6.3.3.4 of TS 23.287 [5] can be used, where the Link Modification Request message is the E2E PC5-S message.

### 6.31.4 Impacts on Services, Entities and Interfaces

UE-to-UE Relay supports the E2E QoS parameters splitting between the two PC5 interfaces.

3GPP TR 38.836 specifies Architecture and Protocol Stack for Layer-2 UE-to-UE relay as follows:

### 5.5 Layer-2 Relay

### 5.5.1 Architecture and Protocol Stack

For L2 UE-to-UE Relay architecture, the protocol stacks are similar to L2 UE-to-Network Relay other than the fact that the termination points are two Remote UEs. The protocol stacks for the user plane and control plane of L2 UE-to-UE Relay architecture are described in FIG. 5.5.1-1 and FIG. 5.5.1-2.
An adaptation layer is supported over the second PC5 link (i.e. the PC5 link between Relay UE and Destination UE) for L2 UE-to-UE Relay. For L2 UE-to-UE Relay, the adaptation layer is put over RLC sublayer for both CP and UP over the second PC5 link. The sidelink SDAP/PDCP and RRC are terminated between two Remote UEs, while RLC, MAC and PHY are terminated in each PC5 link.

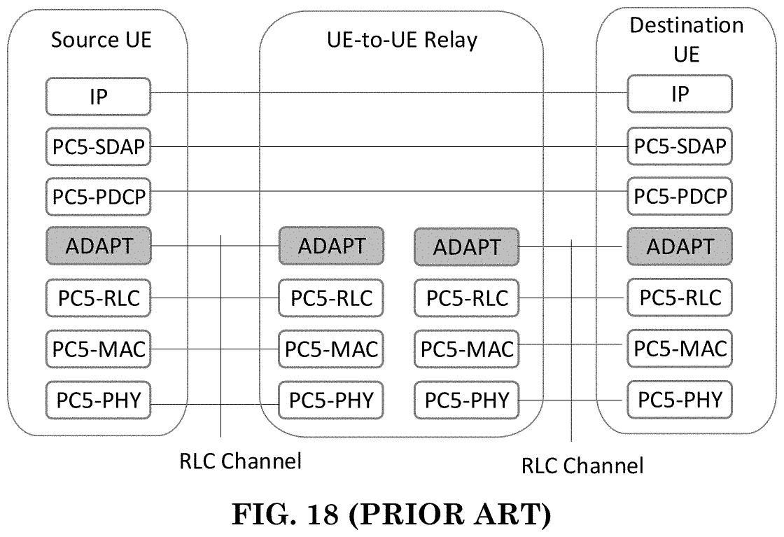

### FIG. 5.5.1-1 of 3GPP TR 38.836 V1.0.0, Entitled “User Plane Protocol Stack for L2 UE-to-UE Relay”, is Reproduced as FIG. 18

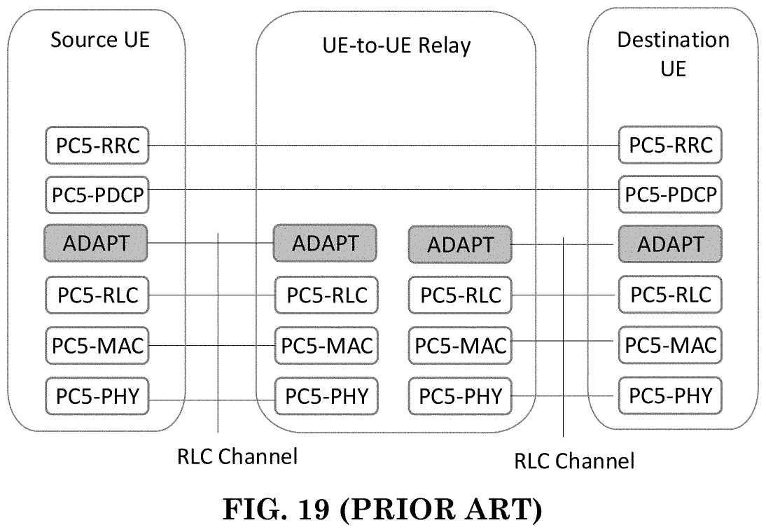

### FIG. 5.5.1-2 of 3GPP TR 38.836 V1.0.0, Entitled “Control Plane Protocol Stack for L2 UE-to-UE Relay”, is Reproduced as FIG. 19

For the first hop of L2 UE-to-UE Relay,
The N:1 mapping is supported by first hop PC5 adaptation layer between Remote UE SL Radio Bearers and first hop PC5 RLC channels for relaying.
The adaptation layer over first PC5 hop between Source Remote UE and Relay UE supports to identify traffic destined to different Destination Remote UEs.
   For the second hop of L2 UE-to-UE Relay,
The second hop PC5 adaptation layer can be used to support bearer mapping between the ingress RLC channels over first PC5 hop and egress RLC channels over second PC5 hop at Relay UE.
PC5 Adaptation layer supports the N:1 bearer mapping between multiple ingress PC5 RLC channels over first PC5 hop and one egress PC5 RLC channel over second PC5 hop and supports the Remote UE identification function.
   For L2 UE-to-UE relay,
The identity information of Remote UE end-to-end Radio Bearer is included in the adaptation layer in first and second PC5 hop.
In addition, the identity information of Source Remote UE and/or the identity information of Destination Remote UE are candidate information to be included in the adaptation layer, which are to be decided in WI phase.

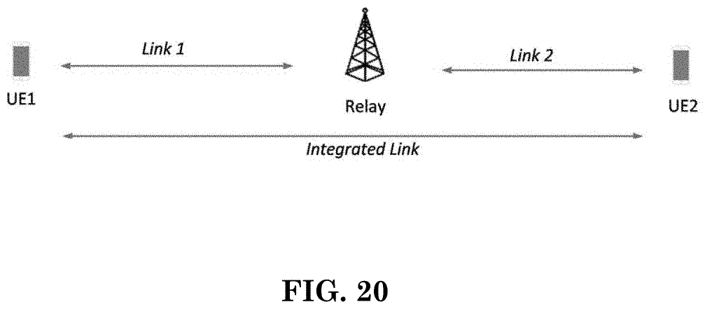

Key issue #4 in 3GPP TR 23.752-040 describes support of UE-to-UE Relay in the following release (i.e. Release 17), which means a relay may be used to support data communication between two UEs in case these two UEs cannot communicate with each other directly. It is supposed that a UE-to-UE Relay needs to establish one PC5 unicast link with each of a Source UE and a Target UE such that the integrated (or extended) PC5 unicast link between the Source UE and the Target UE can support the concerned ProSe service as illustrated in FIG. 20.

3GPP TS 23.287 specifies a Link Identifier Update procedure for updating identifiers used for unicast mode of V2X communication over PC5 reference point, which may include an Application Layer ID, a Layer-2 ID, an IP address/prefix, and/or security information. The security information may be used for protecting communication between the first UE and the second UE. When receiving a Link Identifier Update Request message from a UE, the peer UE may change its identifiers and include them in a Link Identifier Update Response message sent to the UE.

FIG. 15 (which is a reproduction of FIG. 6.9.2.2-1 of 3GPP TR 23.752 V0.4.0) illustrates procedures for Link Identifier Update in the scenario of a UE-to-UE relaying. Basically, the Link Identifier Update procedure is performed after the sidelink security has been established between two concerned UEs. Since the Layer-2 ID of the Source UE is used for communications on the PC5 unicast link between the Source UE and the UE-to-UE Relay and the Layer-2 ID of the Target UE is used for communications on the PC5 unicast link between the Target UE and the UE-to-UE Relay while other identities (e.g. an Application Layer ID and an IP address/prefix) are used for communications between the Source UE and the Target UE and should not be exposed to the UE-to-UE Relay, Solution #9 in 3GPP TR 23.752 proposes two types of Link Identifier Update procedure in FIG. 15. One type of Link Identifier Update procedure is used for updating Layer-2 ID(s) between the Source UE and the UE-to-UE Relay as well as for updating Layer-2 ID(s) between the Target UE and the UE-to-UE Relay. The other type of Link Identifier Update procedure is used for updating other identities (e.g. an Application Layer ID and/or an IP address/prefix) between the Source UE and the Target UE. An indication (e.g. “extended link” indication) is inlcuded in the Link Identifier Update Request message for the UE-to-UE Relay to identify the related procedure (or to distinguish one procedure from the other procedure).

Since the Application Layer ID and/or the IP address/prefix of the Source UE (or the Target UE) should not be exposed to the UE-to-UE Relay, one way to realize this is to cipher, with an end-to-end security context, the content of the Link Identifier Update Request message used to carry the Application Layer ID and/or the IP address/prefix. The end-to-end security context refers to a security key and a security algorithm known between the Source UE and the Target UE (i.e. unknown to the UE-to-UE Relay). According to 3GPP standards (as discussed in 3GPP TS 38.323), the ciphering function is performed in the PDCP layer and the data part in a PDCP Data PDU shall be ciphered. Because the PC5-S message delivered from the upper layer (i.e. PC5 Signaling Protocol) forms the data part in a PDCP Data PDU, the whole PC5-S message will be ciphered. Therefore, the UE-to-UE Relay would not be able to read the indication included in the Link Identifier Update Request message to identify the related procedure and thus the solution proposed in 3GPP TR 23.752 is not feasible. Another solutions should be considered for the UE-to-UE Relay (or the relay UE) to distinguish whether a PC5-S message is destined for the UE-to-UE Relay or for the Target UE.

Since there may be an end-to-end security between the Source UE and the Target UE as well as a local security between each of these two UEs and the UE-to-UE Relay, there is also a need for the UE-to-UE Relay to distinguish whether a PC5-S message used to establish the concerned security is destined for the UE-to-UE Relay or for the peer UE. The related solutions may also be applicable to other PC5-S messages which may be transmitted after the sidelink security has been established between two concerned UEs (e.g. the Link Modification Request message) due to the same consideration.

As shown in FIG. 5.5.1-2 of 3GPP TR 38.836 V1.0.0 (which is reproduced as FIG. 19), an adaptation layer may be added between the PC5-RLC layer and the PC5-PDCP layer in each UE and a Layer-2 UE-to-UE relay. One potential solution is for a Source UE to include information in the header of an adaptation layer PDU used to carry a PC5-S message. When receiving this PDU, the UE-to-UE Relay can know whether the PC5-S message in this PDU is destined for itself (i.e. the UE-to-UE relay) or for the Target UE according to the information. In case the Source UE may communicate with multiple Target UEs via the UE-to-UE Relay, the information may indicate the destination of the PC5-S message, where the destination may be the UE-to-UE Relay or one of the Target UEs.

For example, the information could be an identity information and a specific value of the identity information may be used to identify the UE-to-UE Relay. The identity information is a field in the header. In one embodiment, the specific value may be a value with all bits of the identity information (or the field) set to “0” or “1”, e.g. “000” or “111” in case 3 bits are used to define the identity information. The rest values may then be used to identify other Target UEs. The values used to identify other Target UEs may be assigned by the Source UE and then delivered to the UE-to-UE Relay. It is also possible that these values are assigned by the UE-to-UE Relay and then delivered to the Source UE.

The UE-to-UE Relay may then deliver the received PC5-S message (or the corresponding SDU) to its upper layer (i.e. PDCP) if the information indicates the PC5-S message is for the UE-to-UE Relay. Otherwise, the UE-to-UE Relay may forward the received PC5-S message (or the corresponding SDU) to the concerned Target UE.

In case of a Layer-3 UE-to-UE Relay, the adaptation layer may be added between the PC5-PDCP layer and the PC5 Signaling Protocol layer in each UE and the Layer-3 UE-to-UE relay. Similarly, information may be included in the header of the adaptation layer PDU used to carry the PC5-S message to indicate the destination of the PC5-S message.

In the above solution, the PC5-S messages destinated to the UE-to-UE Relay and the Target UE could be transmitted on the same sidelink SRB. In this situation, the PDCP entity of the sidelink SRB may need to handle two different sets of security parameters: one set for the local security and the other set for the end-to-end security. To avoid this complexity, another alternative solution could be that the PC5-S message destined for the UE-to-UE Relay and the PC5-S message destined for the Target UE could be transmitted on two different sidelink SRBs. By this way, the UE-to-UE Relay may then determine how to handle the received PC5-S message e.g. to deliver the received PC5-S message (or the corresponding SDU) to its upper layer (i.e. a PC5 Signaling Protocol) or to forward the received PC5-S message (or the corresponding SDU) to the Target UE, according to which sidelink SRB the PC5-S message is received on. Each sidelink SRB may be assocaited with a logical channel identity (LCID), which may be included in a MAC header of a MAC PDU used to carry the PC5-S message. In this situation, the PC5-S messages transmitted on these two sidelink SRBs would be ciphered with different sets of security parameters. One set could be used for PC5-S messages exchanged between the Source UE and the UE-to-UE Relay (i.e. the local security), and the other set could be used for PC5-S messages exchanged between the Source UE and the Target UE (i.e. the end-to-end security). In the above example, the PC5-S messages could be transmitted after the sidelink security has been established between two concerned UEs. The same solution may also be applicable to the PC5-S messages which are transmitted to establish the sidelink security. The PC5-S message used to establish the sidelink security may be a DIRECT LINK SECURITY MODE COMMAND message or a DIRECT LINK SECURITY MODE COMPLETE message. For example, one UE could transmit a DIRECT LINK SECURITY MODE COMMAND message to the other UE to initiate the sidelink security establishment procedure and then receives a DIRECT LINK SECURITY MODE COMPLETE message from the other UE to complete the sidelink security establishment procedure.

In one embodiment, the sidelink SRB used for transmitting PC5-S messages to the Target UE could be configured (or assocaited) with an adaptation layer, while the sidelink SRB used for transmitting PC5-S messages to the UE-to-UE Relay is configured (or assocaited) with no adaptation layer.

It may be also feasible for the Source UE to transmit the PC5-S messages destined for the UE-to-UE Relay on a sidelink SRB, while the PC5-S messages destined for the Target UE are trasnmitted on a sidelink DRB. Preferably, the sidelink DRB used for transmitting PC5-S messages to the Target UE is configured (or assocaited) with an adaptation layer, while the sidelink SRB used for transmitting PC5-S messages to the UE-to-UE Relay is configured (or assocaited) with no adaptation layer.

Basically, a PC5-S message could be delivered from the upper layer to the adaptation layer in an adaptation layer SDU. In other words, the PC5-S message could be carried in the SDU, and the adaptation layer could generate an adaptation layer PDU corresponding to the adaptation layer SDU by adding a header for transmission. In other words, an adaptation layer PDU may comprise an adaptation layer SDU and a header. The header may include information identifying the Target UE. The header may also include information identifying the end-to-end Radio Bearer i.e. the DRB used to transmit the PC5-S messages to the Target UE. In case an SRB is used for transmitting the PC5-S messages to the Target UE, the LCID associated with the SRB may be used to identify the end-to-end Radio Bearer (i.e. the SRB).

The above solutions may be applied to both Layer-2 and Layer-3 UE-to-UE Relays.

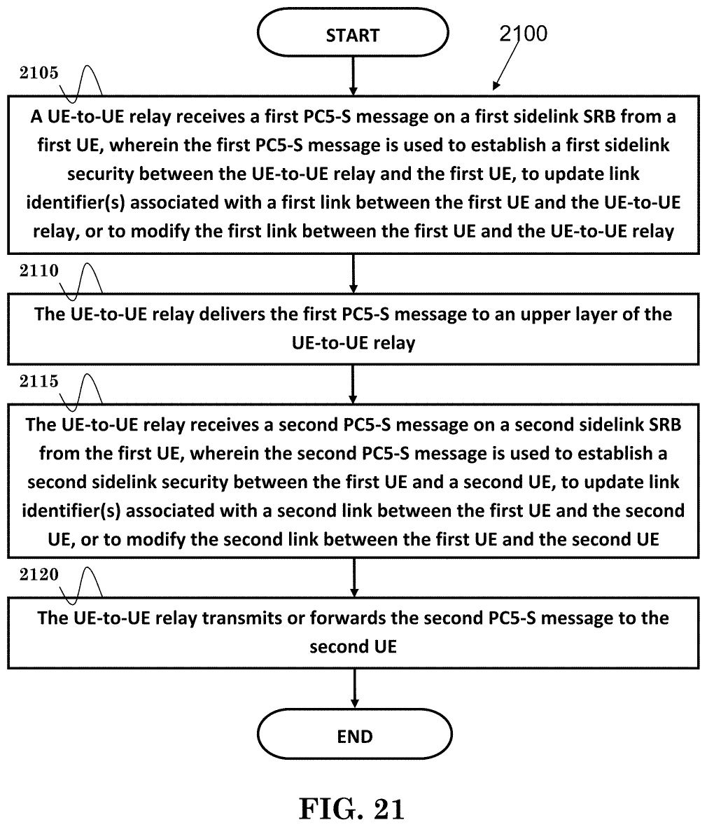

FIG. 21 is a flow chart 2100 illustrating a method for PC5-S message reception from the perspective of a UE-to-UE relay. In step 2105, the UE-to-UE relay receives a first PC5-S message on a first sidelink Signal Radio Bearer (SRB) from a first UE, wherein the first PC5-S message is used to establish a first sidelink security between the UE-to-UE relay and the first UE, to update link identifier(s) associated with a first link between the first UE and the UE-to-UE relay, or to modify the first link between the first UE and the UE-to-UE relay. In step 2110, the UE-to-UE relay delivers the first PC5-S message to an upper layer of the UE-to-UE relay. In step 2115, the UE-to-UE relay receives a second PC5-S message on a second sidelink SRB from the first UE, wherein the second PC5-S message is used to establish a second sidelink security between the first UE and a second UE, to update link identifier(s) associated with a second link between the first UE and the second UE, or to modify the second link between the first UE and the second UE. In step 2120, the UE-to-UE relay transmits or forwards the second PC5-S message to the second UE.

In one embodiment, the second sidelink SRB could be configured with an adaptation layer. The adaptation layer could be located between a PC5 Radio Link Control (PC5-RLC) layer and a PC5 Packet Data Convergence Protocol (PC5-PDCP) layer in the first UE and the UE-to-UE relay if the UE-to-UE relay is a Layer-2 UE-to-UE relay. The first sidelink SRB could be configured with no adaptation layer.

In one embodiment, the second PC5-S message could be included in an adaptation layer Protocol Data Unit (PDU). The adaptation layer PDU could include a header, and the header could include information identifying the second UE.

In one embodiment, the first PC5-S message or the second PC5-S message used to establish the first or second sidelink security could be a Direct Link Security Mode Command message or a Direct Link Security Mode Complete message. The first PC5-S message or the second PC5-S message used to update the link identifier(s) associated with the first link or the second link could be a Link Identifier Update Request message, a Link Identifier Update Response message, or a Link Identifier Update Acknowledgement (ACK) message. The first PC5-S message or the second PC5-S message used modify the first link or the second link could be a Link Modification Request message or a Link Modification Accept message.

In one embodiment, the upper layer of the UE-to-UE relay could be a PC5 Signaling protocol layer.

Referring back to FIGS. 3 and 4, in one exemplary embodiment of a method for a UE-to-UE relay, the UE-to-UE relay 300 includes a program code 312 stored in the memory 310. The CPU 308 could execute program code 312 to enable the UE-to-UE relay (i) to receive a first PC5-S message on a first sidelink SRB from a first UE, wherein the first PC5-S message is used to establish a first sidelink security between the UE-to-UE relay and the first UE, to update link identifier(s) associated with a first link between the first UE and the UE-to-UE relay, or to modify the first link between the first UE and the UE-to-UE relay, (ii) to deliver the first PC5-S message to an upper layer of the UE-to-UE relay, (iii) to receive a second PC5-S message on a second sidelink SRB from the first UE, wherein the second PC5-S message is used to establish a second sidelink security between the first UE and a second UE, to update link identifier(s) associated with a second link between the first UE and the second UE, or to modify the second link between the first UE and the second UE, and (iv) to transmit or forward the second PC5-S message to the second UE. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for PC5 Signaling (PC5-S) message reception, comprising:
a User-Equipment-to-User-Equipment (UE-to-UE) relay receives a first PC5-S message on a first sidelink Signal Radio Bearer (SRB) from a first UE, wherein the first PC5-S message is used to establish a first sidelink security between the UE-to-UE relay and the first UE, to update link identifier(s) associated with a first link between the first UE and the UE-to-UE relay, or to modify the first link between the first UE and the UE-to-UE relay;
the UE-to-UE relay delivers the first PC5-S message to an upper layer of the UE-to-UE relay;
the UE-to-UE relay receives a second PC5-S message on a second sidelink SRB from the first UE, wherein the second PC5-S message is used to establish a second sidelink security between the first UE and a second UE, to update link identifier(s) associated with a second link between the first UE and the second UE, or to modify the second link between the first UE and the second UE; and
the UE-to-UE relay transmits or forwards the second PC5-S message to the second UE.

2. The method of claim 1, wherein the second sidelink SRB is configured with an adaptation layer.

3. The method of claim 2, wherein the adaptation layer is located between a PC5 Radio Link Control (PC5-RLC) layer and a PC5 Packet Data Convergence Protocol (PC5-PDCP) layer in the first UE and the UE-to-UE relay if the UE-to-UE relay is a Layer-2 UE-to-UE relay.

4. The method of claim 1, wherein the first sidelink SRB is configured with no adaptation layer.

5. The method of claim 1, wherein the second PC5-S message is included in an adaptation layer Protocol Data Unit (PDU).

6. The method of claim 5, wherein the adaptation layer PDU includes a header, and the header includes information identifying the second UE.

7. The method of claim 1, wherein the first PC5-S message or the second PC5-S message used to establish the first or second sidelink security is a Direct Link Security Mode Command message or a Direct Link Security Mode Complete message.

8. The method of claim 1, wherein the first PC5-S message or the second PC5-S message used to update the link identifier(s) associated with the first link or the second link is a Link Identifier Update Request message, a Link Identifier Update Response message, or a Link Identifier Update Acknowledgement (ACK) message.

9. The method of claim 1, wherein the first PC5-S message or the second PC5-S message used modify the first link or the second link is a Link Modification Request message or a Link Modification Accept message.

10. The method of claim 1, wherein the upper layer of the UE-to-UE relay is a PC5 Signaling protocol layer.

11. A User-Equipment-to-User-Equipment (UE-to-UE) relay for PC5 Signaling (PC5-S) message reception, comprising:
a control circuit;
a processor installed in the control circuit; and
a memory installed in the control circuit and operatively coupled to the processor;
wherein the processor is configured to execute a program code stored in the memory to:
receive a first PC5-S message on a first sidelink Signal Radio Bearer (SRB) from a first UE, wherein the first PC5-S message is used to establish a first sidelink security between the UE-to-UE relay and the first UE, to update link identifier(s) associated with a first link between the first UE and the UE-to-UE relay, or to modify the first link between the first UE and the UE-to-UE relay;
deliver the first PC5-S message to an upper layer of the UE-to-UE relay;
receive a second PC5-S message on a second sidelink SRB from the first UE, wherein the second PC5-S message is used to establish a second sidelink security between the first UE and a second UE, to update link identifier(s) associated with a second link between the first UE and the second UE, or to modify the second link between the first UE and the second UE; and
transmit or forward the second PC5-S message to the second UE.

12. The UE-to-UE relay of claim 11, wherein the second sidelink SRB is configured with an adaptation layer.

13. The UE-to-UE relay of claim 12, wherein the adaptation layer is located between a PC5 Radio Link Control (PC5-RLC) layer and a PC5 Packet Data Convergence Protocol (PC5-PDCP) layer in the first UE and the UE-to-UE relay if the UE-to-UE relay is a Layer-2 UE-to-UE relay.

14. The UE-to-UE relay of claim 11, wherein the first sidelink SRB is configured with no adaptation layer.

15. The UE-to-UE relay of claim 11, wherein the second PC5-S message is included in an adaptation layer Protocol Data Unit (PDU).

16. The UE-to-UE relay of claim 15, wherein the adaptation layer PDU includes a header, and the header includes information identifying the second UE.

17. The UE-to-UE relay of claim 11, wherein the first PC5-S message or the second PC5-S message used to establish the first or second sidelink security is a Direct Link Security Mode Command message or a Direct Link Security Mode Complete message.

18. The UE-to-UE relay of claim 11, wherein the first PC5-S message or the second PC5-S message used to update the link identifier(s) associated with the first link or the second link is a Link Identifier Update Request message, a Link Identifier Update Response message, or a Link Identifier Update Acknowledgement (ACK) message.

19. The UE-to-UE relay of claim 11, wherein the first PC5-S message or the second PC5-S message used modify the first link or the second link is a Link Modification Request message or a Link Modification Accept message.

20. The UE-to-UE relay of claim 11, wherein the upper layer of the UE-to-UE relay is a PC5 Signaling protocol layer.
